(19) United States
(12) Patent Application Publication
(10) Pub. No.: US 2024/0241092 A1
(43) Pub. Date: Jul. 18, 2024

(54) GCXGC PEAK MEASUREMENT

(71) Applicant: J. Samuel Arey, State College, PA (US)

(72) Inventor: J. Samuel Arey, State College, PA (US)

(21) Appl. No.: 18/375,963

(22) Filed: Oct. 2, 2023

Related U.S. Application Data
(60) Provisional application No. 63/439,551, filed on Jan. 17, 2023.

(51) Int. Cl. G01N 30/86

(52) U.S. Cl. CPC G01N 30/8631

(57) ABSTRACT

Techniques are provided to detect constituents and quantify the associated signal in chromatogram data produced by Comprehensive Two-Dimensional Gas Chromatography (GC×GC). A physical model can describe the second-dimension broadening of each chromatogram peak based on that peak's two-dimensional retention time, owing to the isothermal conditions of the second-dimension separation. A peak width can be estimated based on retention time. This insight can lead to a simplified and robust method to detect, delineate, and quantify constituent peaks in the GC×GC chromatogram, including the deconvolution of overlapping peaks. Examples of results are shown for three different complex substances (crude oil, municipal wastewater extract, and lake water extract) separated by GC×GC coupled with various detectors (Flame Ionization Detector, Electron Capture Detector, and Time-of-Flight Mass Spectrometer).

### CROSS-REFERENCES TO RELATED APPLICATIONS

The present application claims priority from and is a non-provisional application of U.S. Provisional Application No. 63/439,551, entitled “GC×GC PEAK MEASUREMENT” filed Jan. 17, 2023, the entire contents of which is herein incorporated by reference for all purposes.

### BACKGROUND

A comprehensive two-dimensional gas chromatograph, hereafter referred to as GC×GC, is an analytical instrument that separates the organic chemical constituents of complex oily substances such as solvent extracts of petroleum, plants, or environmental samples. A GC×GC separates a greater number of constituents than would be separated by a conventional gas chromatograph, typically by an order-of-magnitude or more. When coupled with a chemical detector such as a Flame Ionization Detector (FID), an Electron Capture Detector (ECD), or a Mass Spectrometer (MS), the GC×GC produces an output that can be arranged as a GC×GC chromatogram, which represents the detector output as a two-dimensional surface or a two-dimensional spectrum.

For many substances of interest, GC×GC does not separate completely the constituents on the injected substance, despite that GC×GC exhibits better separation capacity than a conventional gas chromatograph. This incomplete separation typically produces coeluting constituents that are difficult to detect and quantify. A well-separated constituent produces a two-dimensional, unimodal peak in the GC×GC chromatogram. By contrast, coeluting constituents produce overlapping peaks that occur as complex two-dimensional signal shapes, which may be difficult to interpret, depending on the number, extent of overlap, and relative signal intensities of the coeluting constituents. Contributions from instrument noise may further obscure the interpretation.

Available techniques do not fully overcome the difficulties of interpreting GC×GC chromatogram data.

### BRIEF SUMMARY

The disclosure provides methods to detect constituents and quantify the associated signal in GC×GC chromatogram data, referred to collectively as the GC×GC Peak Measurement (GPM) method herein. A physical model can describe the second-dimension broadening of each chromatogram peak based on that peak's two-dimensional retention time, owing to the isothermal conditions of the second-dimension separation. Thus, a second-dimension peak width can be estimated based on retention time. This insight can lead to a simplified and robust method detect, delineate, and quantify constituent peaks in the GC×GC chromatogram, including the deconvolution of overlapping peaks. Examples of results are shown for three different complex substances (crude oil, municipal wastewater extract, and lake water extract) separated by GC×GC coupled with four different detectors (Flame Ionization Detector, Electron Capture Detector, and two Time-of-Flight Mass Spectrometer configurations).

According to one example for performing peak measurement, the GPM method can baseline-correct and smooth the second-dimension segments of the chromatogram, which isolates the second-dimension signal attributed to eluting constituents. The method can detect constituents and determine their second-dimension retention times, e.g., by analyzing the second-dimension signal and its second derivative. The method can then fit a modeled second-dimension signal profile, referred to as a “peaklet”, to each detected constituent within each observed second-dimension signal profile. To accomplish this, the method can represent the peaklet shape with a parameterized function, which may be skewed, such as an Exponentially Modified Gaussian (EMG) function. The method can determine the second-dimension width of each peaklet with a physical model that calculates the width parameter from the peaklet's two-dimensional retention time. The method can then determine the intensities of the peaklets by minimizing the absolute difference between the sum of the peaklets and the observed profile of the second-dimension signal. Finally, the method can delineate and quantify two-dimensional peaks in the chromatogram by a procedure that conjoins qualifying second-dimension peaklets along the first dimension. The method can detect, delineate, and quantify peaks in single-channel chromatogram data (e.g., GC×GC-FID, GC×GC-ECD) and also support the deconvolution of spectral chromatogram data (e.g., GC×GC-MS).

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 shows a schematic of the main components of a GC×GC instrument, including the injector, first column, second column, modulator, and chemical detector.

FIG. 2 illustrates a schematic showing idealized detector output from the GC×GC instrument for a well-separated constituent. A “peaklet” refers to a second-dimension signal profile that is associated with the constituent. For the middle peaklet, labels indicate the second-dimension retention time (t₂), width parameter (σ), and height (h) of the peaklet. A “peak” refers to the set of peaklets associated with the constituent.

FIG. 3 shows a chromatogram from a GC×GC-FID separation of a crude oil, depicted as a heat map of detector output intensity. The inset (top left) shows an expanded view of the region eluting between 89 to 101 min (first dimension) and 0.5 to 3.0 s (second dimension). GC×GC-FID is well-suited to the separation and quantification of constituents in petroleum substances and plant extracts. The GC×GC-FID separation was conducted by Robert K. Nelson at Woods Hole Oceanographic Institution, Falmouth, MA (Nelson et al. 2022).

FIG. 4 shows a two-dimensional chromatogram of the ion having molecular mass of 137.1325 Daltons, for a crude oil sample, separated by GC×GC coupled to High-Resolution Time-of-Flight Mass Spectrometry with Electron Impact ionization (GC×GC-EI-HR-TOFMS). The inset (top left) shows an expanded view of the region eluting between 68 to 80 min (first dimension) and 2 to 6.5 s (second dimension). The ion 137.1325 represents the accurate molecular mass for the fragment, C₁₀H₁₇⁺, which is typically interpreted as a fused two-ring hydrocarbon (decalin) substructure that occurs in many naphthenic petroleum hydrocarbon constituents. The GC×GC-EI-HR-TOFMS separation was conducted by Robert K. Nelson at Woods Hole Oceanographic Institution, Falmouth, MA (Nelson et al. 2022).

FIG. 5 shows a two-dimensional chromatogram of a Swiss municipal wastewater extract, separated by GC×GC-μECD. The inset (top left) shows an expanded view of the region eluting between 21 to 30 min (first dimension) and 1 to 10 s (second dimension). The μECD detector is selective for halogenated chemicals such as chlorine-bearing pesticides, brominated flame retardants, and certain legacy pollutants. The GC×GC-μECD separation was conducted by Petros Dimitriou-Christidis while working at the École Polytechnique Fédérale de Lausanne, in Lausanne, Switzerland (Gros et al. 2012).

FIG. 6 shows a two-dimensional chromatogram of a lake water extract taken from Lake Geneva, separated by GC×GC coupled to Time-of-Flight Mass Spectrometry with Electron Capture Negative Chemical Ionization (GC×GC-ENCI-TOFMS). The inset (top left) shows an expanded view of the region eluting between 17 to 26 min (first dimension) and 1 to 4.5 s (second dimension). The heat map exhibits the Total Ion Chromatogram, which is the sum of the intensities of all ions detected by the mass spectrometer. The ENCI-TOFMS detector is selective for halogenated chemicals such as chlorine-bearing pesticides, brominated flame retardants, and certain legacy pollutants. The GC×GC-ENCI-TOFMS separation was conducted by Saer Samanipour while working at the École Polytechnique Fédérale de Lausanne, in Lausanne, Switzerland (Samanipour et al. 2015).

FIG. 7 shows a flow chart of a GPM method according to embodiments of the present disclosure.

FIGS. 8A-8B and 9A-9B illustrate the results of a delineation of a single peak (“analyte”) centered at 95.008 min (first dimension) and 1.25 s (second dimension) in the GC×GC-FID chromatogram of a crude oil shown in FIG. 3. FIGS. 8A-8B and 9B display various representations of the chromatogram signal (vertical axis) versus the second-dimension retention time (horizontal axis) of the second-dimension segments containing the delineated analyte which is centered at 95.008 min and 1.25 s. FIG. 9A illustrates a heat map of the region of the chromatogram containing the delineated analyte which is centered at 95.008 min and 1.25 s. The approximate boundaries of the delineated analyte are shown by a white-outline polygon.

FIGS. 10A-10B and 11A-11B illustrate the results of a delineation of a single peak (“analyte”) centered at 73.750 min (first dimension) and 4.42 s (second dimension) in the chromatogram of the ion with a mass of 137.1325 Daltons, from the separation of a crude oil by GC×GC-EI-HR-TOFMS shown in FIG. 4. FIGS. 10A-10B and 11B display various representations of the chromatogram signal (vertical axis) versus the second-dimension retention time (horizontal axis) of the second-dimension segments containing the delineated analyte which is centered at 73.750 min and 4.42 s. FIG. 11A illustrates a heat map of the region of the chromatogram containing the delineated analyte which is centered at 73.750 min and 4.42 s. The approximate boundaries of the delineated analyte are shown by a white-outline polygon.

FIGS. 12A-12B and 13A-13B illustrate the results of a delineation of a single peak (“analyte”) centered at 25.750 min (first dimension) and 5.73 s (second dimension) in the GC×GC-μECD chromatogram of a wastewater extract shown in FIG. 5. FIGS. 12A-12B and 13B display various representations of the chromatogram signal (vertical axis) versus the second-dimension retention time (horizontal axis) of the second-dimension segments containing the delineated analyte which is centered at 25.750 min and 5.73 s. FIG. 13A illustrates a heat map of the region of the chromatogram containing the delineated analyte which is centered at 25.750 min and 5.73 s. The approximate boundaries of the delineated analyte are shown by a white-outline polygon.

FIGS. 14A-14B and 15 illustrate the results of a delineation of a single peak (“analyte”) centered at 21.600 min (first dimension) and 2.66 s (second dimension) in the Total Ion Chromatogram of a GC×GC-ENCI-TOFMS separation of a lake water extract shown in FIG. 6. FIGS. 14A-14B display various representations of the chromatogram signal (vertical axis) versus the second-dimension retention time (horizontal axis) of the second-dimension segments containing the delineated analyte which is centered at 21.600 min and 2.66 s. FIG. 15 illustrates a heat map of the region of the chromatogram containing the delineated analyte which is centered at 21.600 min and 2.66 s. The approximate boundaries of the delineated analyte are shown by a white-outline polygon.

FIG. 16 illustrates a measurement system according to an embodiment of the present disclosure.

FIG. 17 shows a block diagram of an example computer system usable with systems and methods according to embodiments of the present disclosure.

### TERMS

The term “GC×GC chromatogram” refers to the GC×GC output arranged as a two-dimensional surface or a two-dimensional spectrum, usually reported by first-dimension retention time on the horizontal axis and second-dimension retention time (also referred to as second-dimension retention time values) on the vertical axis. The chromatogram represents a two-dimensional array in the case of single-channel detector output, or a two-dimensional spectrum in the case of spectral detector output.

The term “column” refers to a gas chromatography column, consisting of a hollow tubular support with an interior film coating called the stationary phase. Injected constituents become separated during transport through the column, due to their differences in affinity for the stationary phase. In a GC×GC instrument, the compositions of the stationary phase differ between the first chromatographic column (or “first column”) and the second chromatographic column (or “second column”), such that the two columns exhibit differing separation properties.

The term “carrier gas” refers to a gas (typically H₂, He, or N₂) that is injected continuously into the first column during a GC×GC separation. During their transport through the column, injected constituents spend some of the time in the carrier gas and some of the time in the stationary phase. Two injected constituents become chromatographically separated if they have physical properties that cause them to spend differing amounts of time in the gas phase versus the stationary phase, on average.

The term “single-channel detector output” refers to detector output that contains a single quantitative datum at each measurement time point. Examples include output from Flame Ionization Detector (FID), output from Electron Capture Detector (ECD), and output representing a single ion from a Mass Spectrometer (MS).

The term “spectral detector output” refers to detector output that contains a vector of quantitative data from multiple channels, at each measurement time point. The vector of detector measurements represents a 2-D spectrum, at each time point. Each vector element represents the measured intensity (ordinate value) of a distinct spectral channel (abscissa value), where the spectral channel typically represents mass or wavelength. Examples include output from a Mass Spectrometer (MS) and output from a Vacuum Ultraviolet (VUV) absorption spectrophotometer.

The “first-dimension retention time” (t₁) of a substance constituent refers to the amount of time that transpires between (a) the release of the constituent from the injector into the first chromatographic column of the GC×GC and (b) the measurement of the constituent at the detector. The first-dimension retention time of the constituent is defined operationally as the recorded time point of the modulation of the most intense (i.e., highest) peaklet which is attributed to the constituent. Also see peaklet, below.

The “second-dimension retention time” (t₂) of a substance constituent refers to the amount of time that transpires between (a) the release of the constituent from the modulator into the second chromatographic column of the GC×GC and (b) the measurement of the constituent at the detector. For any peaklet attributed to the constituent, the second-dimension retention time of the peaklet is defined operationally as the recorded time point of maximum signal intensity attributed to that peaklet. Also see peaklet, below.

The term “modulator” refers to a device that continually entraps constituents eluting from the first column. The modulator releases these trapped constituents into the second column at a regular time interval, called the modulation period.

The term “peak”, in the context of GC×GC data, refers to a two-dimensional signal shape in the GC×GC chromatogram that is attributed to a detected constituent. A peak is composed of one or more peaklets.

A “detected constituent” is defined as one or more chemical structures in the injected substance that produce a single unimodal peak shape in the GC×GC chromatogram.

The term “peaklet” refers to a second-dimension signal profile attributed to a detected constituent, as described by a parameterized peaklet shape function. Also see peaklet shape function, below.

The term “second-dimension segment” refers to the second-dimension profile of detector output that spans one modulation period, at a single value of the first-dimension retention time.

The term “second-dimension signal” is defined as the portion of the second-dimension segment that contains information content about eluting constituents. The signal is distinguished from detector noise (which is reduced by smoothing) and from the stable detector output in the absence of eluting constituents (which is reduced by baseline-correction).

The term “explained signal” (or fitted signal) refers to the sum of the fitted peaklet shape functions within a second-dimension segment. The explained signal can be compared with the observed second-dimension signal.

The term “width parameter” refers to a, which characterizes the width of a peaklet, as implemented by the peaklet shape function.

The term “physical model” refers to an idealized model of the peaklet width parameter, c, which assumes that the broadening of a one-dimensional gas chromatography peak can be estimated based on information about the elution conditions during an isothermal separation process, e.g., without apriori knowledge of the chemical identity of the constituent. The physical model can estimate the value of abased on parameters that describe the isothermal separation conditions experienced by the peaklet in the GC×GC second dimension. Parameters of the physical model can include, but are not limited to, the second-dimension retention time of the peaklet and the temperature of the secondary oven. Examples of the physical model can be found in published chromatography theory, e.g. (Giddings 1965, Grob et al. 2004).

The term “peaklet shape function” refers to a function that can describe the shape and size of a peaklet. The peaklet shape function can take as input the second-dimension retention time, width parameter, and height of the peaklet, or transformations of these parameters. The peaklet shape function can have a peak and then the function can decay, e.g., exponentially. The peaklet shape function can be skewed, such that it is asymmetric. Examples are Gaussian-like functions such as a Gaussian function, an Exponentially Modified Gaussian (EMG) function, or a skewed Gaussian function.

The term “peak delineation” refers to the procedure of defining the signal boundary of a peak in a GC×GC chromatogram, which determines the shape and size of the peak. Peak delineation therefore also quantifies the cumulative signal intensity attributed to the peak. The peak signal boundary is a single-valued function of three coordinates: the first-dimension retention time, the second-dimension retention time, and signal intensity. Therefore, the peak boundary appears as a unimodal three-dimensional surface having a shape that approximately resembles a mountain.

The term “instrument configuration” refers to the combination of physical hardware and gases that are implemented for a particular GC×GC instrument when it is employed to separate a substance sample. The instrument configuration includes but is not limited to: the injector; the GC oven; the secondary oven; the modulator; the dimensions (inner diameters and lengths) of the chromatographic columns and sections of non-chromatogram column (e.g., transfer lines); the types and thickness of the stationary phases employed in the chromatographic columns; the type(s) of detectors employed, the carrier gas that is employed; the modulator gas that is employed (usually N₂); and the types of fittings used to join the column pieces.

The term “instrument program” refers to the internal conditions of the instrument throughout the separation of a substance sample, including the timing of all changes in these conditions. The instrument program includes but is not limited to: the temperature of the injector; the flow rate of the carrier gas throughout the separation; the initial temperatures, temperature ramp rates, and final temperatures of both the main oven and the secondary oven; the modulation period; the detector acquisition rate; the conditions of the detector (which vary depending on the detector type); and the timing and flow rate of the gas employed by the modulator (which typically alternates flows of a hot gas jet and a cold gas jet).

### DETAILED DESCRIPTION

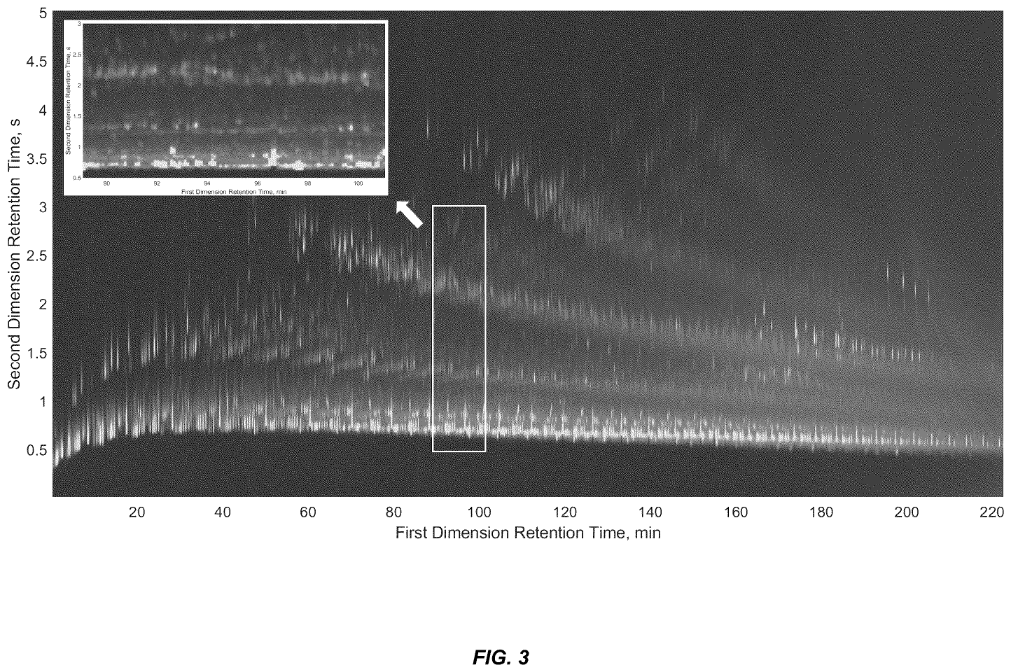

Comprehensive two-dimensional gas chromatography (GC×GC) can separate hundreds or thousands of constituents in complex oily liquids such as petroleum substances and solvent extracts of plants and environmental samples. Nonetheless, the formidable separation capacity of GC×GC is often insufficient to completely resolve the constituents of these samples (e.g., FIGS. 3-6), and further methods are needed to interpret the complex, multimodal signal shapes that represent coeluting constituents in GC×GC chromatograms. However, previous techniques to detect and attribute the signal shapes in GC×GC chromatograms suffer various shortcomings.

The GC×GC Peak Measurement (GPM) method can detect constituents in the GC×GC chromatogram, and it can also delineate and quantify the signal region (“peak”) attributed to each constituent. The method can deconvolute overlapping peaks, including cases in which signal shouldering obscures the signal maxima attributed to some of the peaks. Unlike other techniques, embodiments of the GPM method can detect and delineate peaks using a physical model, which can estimate the peaklet widths in the second dimension. A resulting procedure can efficiently and robustly detect and delineate peaks, encompassing cases where peaks are overlapped and cases where peaks are well-separated.

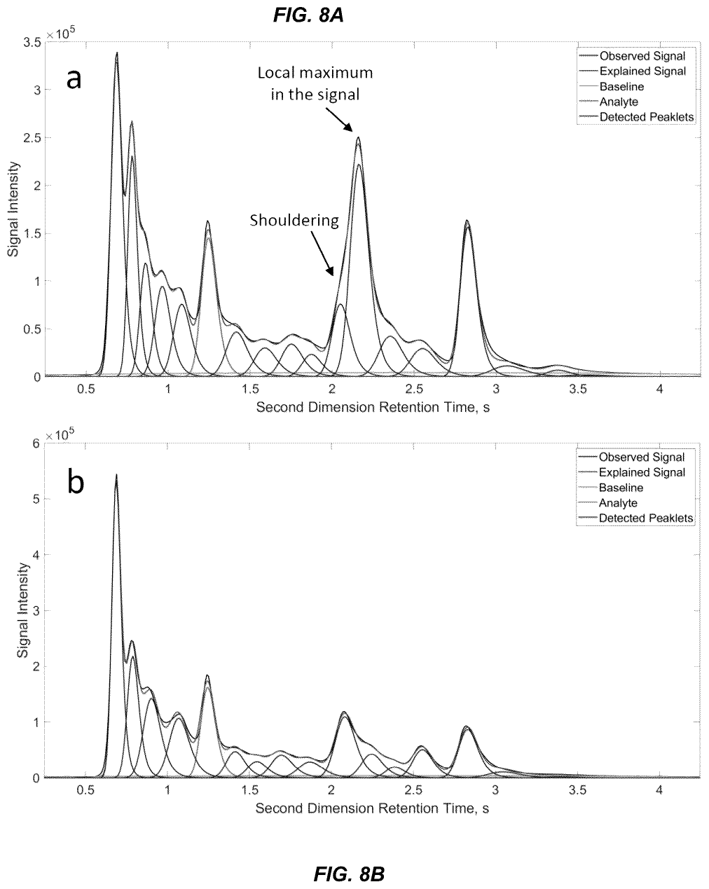

Results are shown for four GC×GC chromatograms that represent the separations of three different complex substances by four different GC×GC instrument configurations, employing four different detectors (FIGS. 8-11). The three substances were a crude oil, a municipal wastewater extract, and a lake water extract, which exhibit widely differing chemical compositions. The four detectors employed were FID, EI-HR-TOFMS, μECD, and ENCI-TOFMS. Each of these detectors possesses different capabilities, which suit it to different types of constituents and research questions. The separations were carried out with four different GC×GC instruments located on two different continents using widely varied instrument programs. This dataset of real samples poses a diversity of realistic challenges to the interpretation of GC×GC chromatograms. The dataset spans a wide range of sample compositions, instrument configurations, instrument programs, chromatogram resolutions, and levels of analyst experience. The presented results demonstrate that the GPM method can successfully detect and delineate peaks in all of these GC×GC chromatograms, revealing the efficiency and robustness of the method.

### I. GC×GC

A comprehensive two-dimensional gas chromatograph, hereafter referred to as GC×GC, is an analytical instrument that separates the organic chemical constituents of complex oily substances such as petroleum substances and solvent extracts of plants or environmental samples. In this context, a complex oily substance is defined as a hydrophobic liquid that contains hundreds, thousands, or more constituents having variable chromatographic properties. A GC×GC employs two conjoined gas-chromatography columns that are interfaced with a modulator.

### A. The GC×GC Instrument

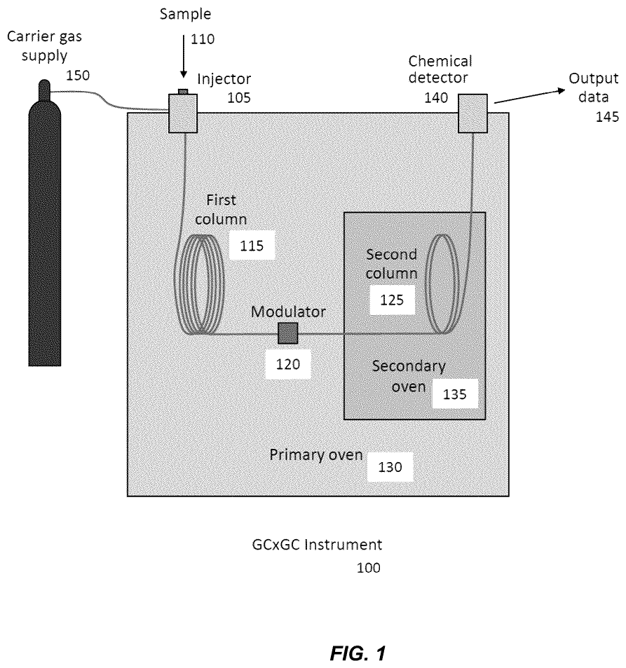

FIG. 1 shows a schematic of the main components of a GC×GC instrument 100. A primary oven 130 and a secondary oven 135 permit different temperature programs to be applied to a first column and a second column. Some GC×GC instruments do not have a secondary oven, in which case the second column resides in the primary oven.

In the example shown, an injector 105 introduces a sample 110 into a first chromatographic column 115. A gas supply continually injects a carrier gas 150 (e.g., H₂, He, or N₂) into the first column, which carries the chemical constituents through the column and thereby separates the chemical constituents according to differences in their affinity to the column stationary phase. This process is called the first-dimension separation, and it transpires on a time frame that can range from several minutes to a few hours, depending on the programmed instrument conditions and the properties of the eluting constituents.

A modulator 120 is a short section of non-chromatographic column that continuously entraps constituents (e.g., by cooling the exterior of the modulated section with a cryogenic gas jet) eluting from the first chromatographic column 115. At regular time intervals, the modulator 120 comprehensively releases these trapped constituents into a second chromatographic column 125. A “modulation period” refers to the length of the regular time interval during which the modulator 120 entraps constituents before releasing them into the second chromatographic column 125. The GC×GC analyst typically employs a modulation period that ranges between several seconds and half a minute. The release of constituents from the modulator 120 (e.g., by heating the exterior of the modulated section with a hot gas jet), transpires during a short time interval, e.g., a fraction of a second.

The second chromatographic column 125 further separates the modulated constituents, called the second-dimension separation. The second-dimension separation transpires on a time frame of several seconds, and shorter than the modulation period. The modulation period is a fraction of a minute in duration, whereas the first-dimension separation may span hours, such that many second-dimension separations occur during a single GC×GC separation of an injected sample.

To facilitate the separation of constituents encompassing a wide range of properties, the analyst typically programs the GC×GC instrument such that both columns are slowly heated according to temperature ramps throughout the separation of the sample. The slow separation of constituents by the first column occurs under temperature-ramp conditions, whereas the comparatively rapid separation of constituents by the second column occurs under approximately isothermal conditions. To permit detection of chemical constituents eluting from the GC×GC, the secondary column outlet is joined to a chemical detector 140, commonly either a Flame Ionization Detector (FID), Electron Capture Detector (ECD), or Mass Spectrometer (MS), although other detectors may be used.

In this way, a GC×GC produces a two-dimensional separation of the chemical constituents, which contrasts with the one-dimensional separation of a conventional gas chromatograph. As a consequence, a GC×GC separates a greater number constituents than would be separated by a conventional gas chromatograph, typically by an order-of-magnitude or more, when applied to complex substances. When coupled with a chemical detector such as an FID, ECD, or MS, the GC×GC instrument produces output data 145 that can be arranged as a GC×GC chromatogram, which represents the detector output as a two-dimensional surface or a two-dimensional spectrum.

When the GC×GC is coupled with a single-channel detector such as FID or ECD, the chromatogram represents a two-dimensional (N₁×N₂) array of quantitative detector output, where N₁ represents the number of modulations and N₂ represents the number of detector measurements within a single modulation. When the GC×GC is coupled with an MS or another spectral detector, the chromatogram represents a three-dimensional (N₁×N₂×N_{c}) array of quantitative detector output, where No is the number of measured spectral channels.

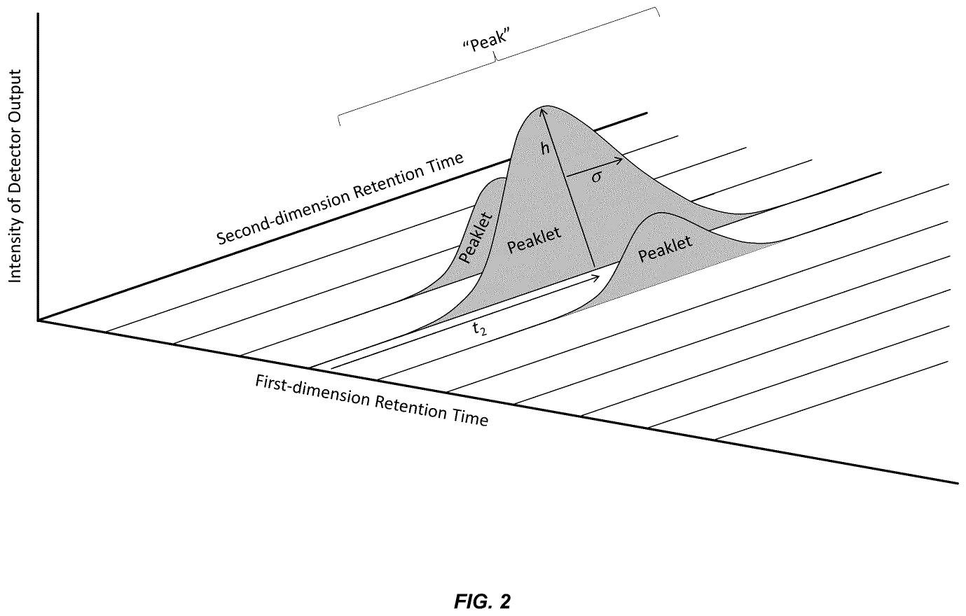

FIG. 2 illustrates a schematic showing idealized detector output from the GC×GC instrument for a well-separated constituent. The detector output is arranged as a two-dimensional array of intensity data, displayed with respect to first-dimension retention time on one coordinate axis and second-dimension retention time on the second coordinate axis. A “peaklet” refers to an individual second-dimension signal profile associated with the detected constituent. For the middle peaklet, labels indicate the second-dimension retention time (t₂), width parameter (σ), and height (h) of the peaklet. A “peak” refers to the set of peaklets that are associated with the detected constituent.

FIG. 3 shows the intensity surface of a two-dimensional chromatogram of a crude oil sample separated with GC×GC-FID, depicted as a heat map. GC×GC-FID is well-suited to the separation and quantification of constituents in petroleum substances such as crude oils, heating oils, fuels, and lubricants, and also plant extracts such as essential oils and fragrances. The separation exhibits a well-resolved, patterned chromatogram, corresponding to the presence of homologous series of petroleum constituents that span many distinct classes. The inset (top left) shows an expanded view of the region eluting between 89 to 101 min (first dimension) and 0.5 to 3.0 s (second dimension). In the heat map, a well-separated constituent appears as a light-colored feature that resembles an isolated, unimodal distribution in both dimensions. By contrast, complex multimodal distributions are apparent in many regions of the chromatogram (heat map), indicating overlap among numerous constituents. These complex signal shapes are difficult to interpret using previous techniques for GC×GC peak detection and delineation. The GC×GC-FID separation was conducted by Robert K. Nelson at Woods Hole Oceanographic Institution, in Falmouth, MA (Nelson et al. 2022).

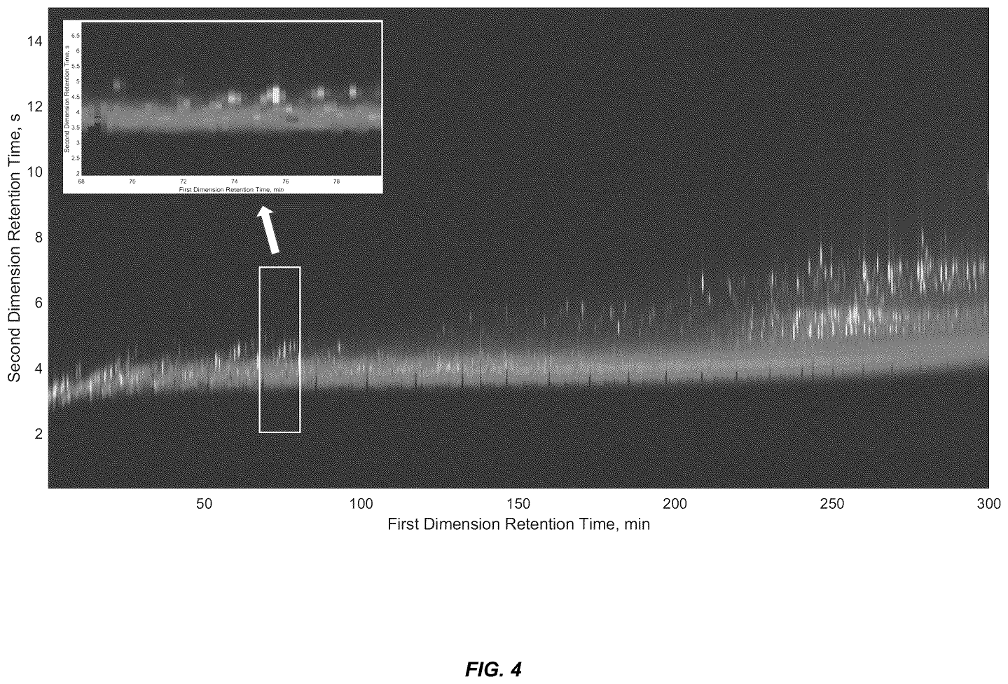

FIG. 4 shows a two-dimensional chromatogram of the ion having molecular mass of 137.1325 Daltons, for the crude oil sample shown in FIG. 3, separated by GC×GC coupled to High-Resolution Time-of-Flight Mass Spectrometry with Electron Impact ionization (GC×GC-EI-HR-TOFMS). The inset (top left) shows an expanded view of the region eluting between 68 to 80 min (first dimension) and 2 to 6.5 s (second dimension). The ion 137.1325 represents the accurate molecular mass for the fragment, C₁₀H₁₇⁺, which is typically interpreted as a fused two-ring hydrocarbon (decalin) substructure that occurs in many naphthenic petroleum hydrocarbon constituents. Due to the spectral separation provided by the EI-HR-TOFMS, this chromatogram exhibits decreased complexity compared to the GC×GC-FID chromatogram of the same crude oil sample (FIG. 3). Nonetheless, multimodal distributions still appear, indicating constituent overlap, in several regions of the chromatogram. The GC×GC-EI-HR-TOFMS separation was conducted by Robert K. Nelson (“Bob”) at Woods Hole Oceanographic Institution, in Falmouth, MA (Nelson et al. 2022).

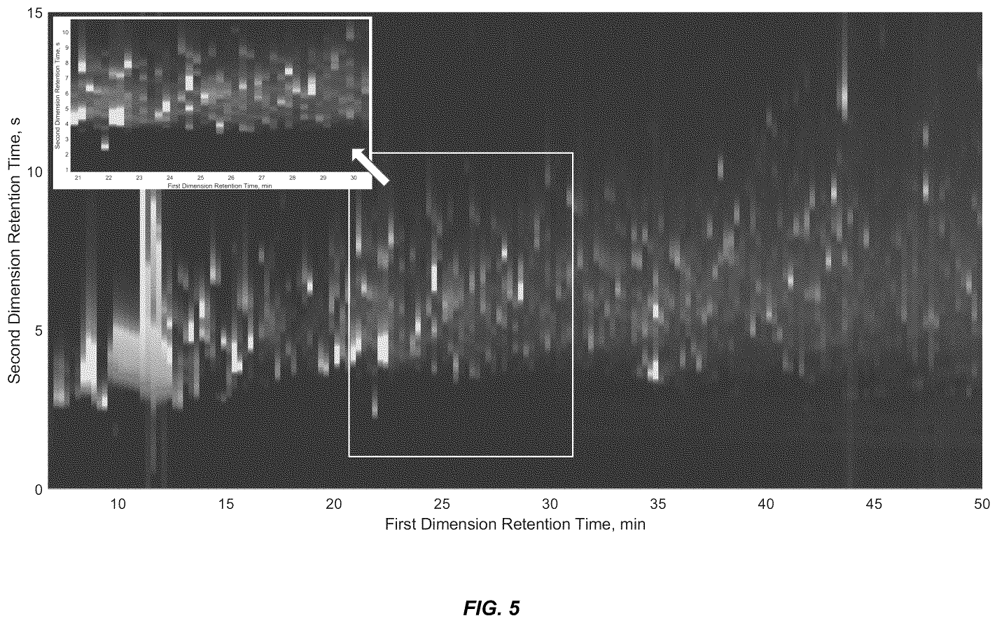

FIG. 5 shows a two-dimensional chromatogram of a Swiss municipal wastewater extract, separated by GC×GC-μECD. The inset (top left) shows an expanded view of the region eluting between 21 to 30 min (first dimension) and 1 to 10 s (second dimension). The μECD (“micro-ECD”) detector is sensitive and selective for halogenated chemicals such as chlorine-bearing pesticides, brominated flame retardants, and certain legacy pollutants like dioxins, PCBs, and DDT. Compared with the crude oil sample (FIG. 3), the wastewater extract exhibits a highly irregular separation pattern that is less amenable to expert interpretation. Compared with the GC×GC-FID separation (FIG. 3), the GC×GC-μECD instrument has been programmed to produce a separation on a much shorter sample analysis time, with the trade-off that the chromatogram exhibits a lower separation capacity. The resulting chromatogram exhibits complex signal shapes that suggest randomly arranged constituents and irregular overlaps. Compared to the GC×GC-FID separation of crude oil (FIG. 3), this GC×GC-μECD separation of wastewater poses differing challenges to the interpretation of the chromatogram signal. The GC×GC-μECD separation was conducted by Petros Dimitriou-Christidis while working at École Polytechnique Fédérale de Lausanne, in Lausanne, Switzerland (Gros et al. 2012).

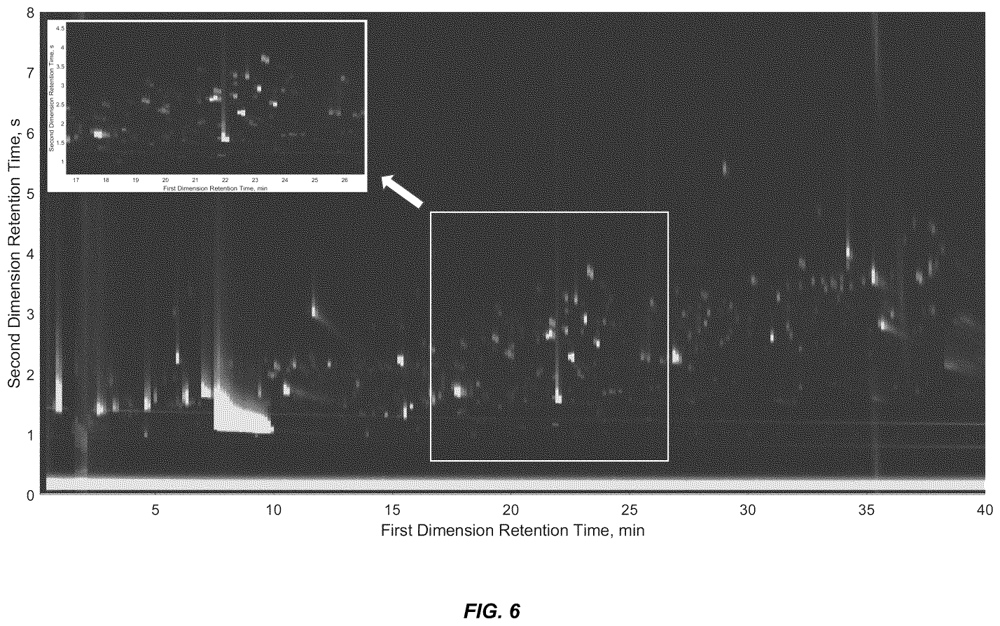

FIG. 6 shows a two-dimensional chromatogram of a lake water extract taken from Lake Geneva, separated by GC×GC coupled to Time-of-Flight Mass Spectrometry with Electron Capture Negative Chemical Ionization (GC×GC-ENCI-TOFMS). The inset (top left) shows an expanded view of the region eluting between 17 to 26 min (first dimension) and 1 to 4.5 s (second dimension). The heat map exhibits the Total Ion Chromatogram, which is the sum of the intensities of all ions detected by the mass spectrometer. The ENCI-TOFMS is a sensitive spectral detector that is useful for the selective detection of halogenated chemicals such as chlorine-bearing pesticides, brominated flame retardants, dioxins, PCBs, and DDT. Compared to the separations exhibited in FIGS. 3-5, this chromatogram exhibits fewer detected constituents and less complex signal shapes, owing the selectivity of the detector and the origin of the sample. The GC×GC-ENCI-TOFMS separation was conducted by Saer Samanipour while working at École Polytechnique Fédérale de Lausanne, in Lausanne, Switzerland (Samanipour et al. 2015).

### B. Detecting and Quantifying Chemical Constituents in the GC×GC Chromatogram

In order to interpret the chemical composition of a substance that is separated by GC×GC, the analyst typically aims to detect the constituents and to quantify the GC×GC signal data (single-channel or spectral) associated with those constituents. However, for many complex substances of interest, GC×GC does not separate completely the constituents (e.g., FIGS. 3-6), despite that GC×GC exhibits better separation capacity than a conventional gas chromatograph. This incomplete separation frequently produces coeluting constituents that are difficult to detect, delineate, and quantify.

In the GC×GC chromatogram, a well-separated constituent produces a single peak that is unimodal in both chromatographic dimensions, assuming that the signal produced by the eluting mass of this constituent exceeds a sufficient signal-to-noise threshold, e.g., the instrument limit of detection. Previous methods can detect, delineate, and quantify the two-dimensional signal peaks for many such cases of well-separated constituents (section IC). However, coeluting constituents produce overlapping peaks that frequently occur as complex two-dimensional signal shapes which may be difficult to interpret, depending on the number, extent of overlap, and relative signal intensities of the coeluting constituents. Interference from instrument noise may further obscure the interpretation.

C. Problems with Other Techniques

Previous authors have developed methods to detect and quantify constituents in GC×GC chromatogram data. However, these approaches suffer shortcomings when applied to the complex two-dimensional chromatogram shapes produced by coeluting constituents. Reichenbach and coworkers developed an “inverted watershed” method that detects, delineates, and quantifies regions of two-dimensional chromatogram data that contain local maxima, which they called “blobs” (Reichenbach et al. 2004, Latha et al. 2011). However, the inverted watershed method incorrectly associates some coeluting constituents into single blobs, because it detects constituents based on observed maxima in the chromatogram: the method does not detect coeluting constituents which produce shouldering or otherwise broadened signal shapes in the GC×GC second dimension. Aside from the information conferred by the observed signal shape, the inverted watershed method lacks additional physical constraints on the width, shape, or concavity of the signal profiles attributed to individual constituents, such that it can misinterpret signal features arising from coelutions in the GC×GC second dimension.

Through their analysis of GC×GC-FID data, Peters and coworkers (Peters et al. 2007) developed a “two-step” method that detects local signal maxima in the GC×GC second dimension. At each local maximum, the method interprets a peaklet as the proximate second-dimension signal associated with that maximum, based on the first-derivative of the signal in the second dimension. The method delineates two-dimensional peaks by conjoining proximate peaklet maxima such that the first-dimension signal profile obeys both a “signal overlap criterion” and a “unimodality criterion”. However, the two-step method only detects constituents that exhibit chromatogram maxima, excluding coeluting constituents which appear instead as shouldering or otherwise broadened signal shapes in the GC×GC second dimension. Aside from the information contained in the observed signal shape, the two-step method lacks additional physical constraints on the width, shape, or concavity of the signal profiles attributed to individual constituents, such that it can misinterpret signal features arising from coelutions in the GC×GC second dimension.

Arey and coworkers developed a method to quantify well-separated constituents in GC×GC data, by fitting each individual peak to a two-dimensional Gaussian function with a locally-determined baseline (Arey et al. 2007), but this method does not detect or quantify overlapped signal peaks arising from coeluting constituents.

All of the above-mentioned methods (Reichenbach et al. 2004, Arey et al. 2007, Peters et al. 2007, Latha et al. 2011) can detect and quantify well-separated two-dimensional peaks in GC×GC chromatograms.

Previously reported methods also include approaches to detect and quantify constituents in one-dimensional chromatographic data, but these methods are not well-adapted to handle the signal shapes produced by GC×GC. Vivó-Truyols and coworkers (Vivó-Truyols et al. 2005a, Vivó-Truyols et al. 2005b) proposed a method to detect and deconvolute peaks separated by one-dimensional liquid chromatography with UV detection, by assuming that the signal shapes of eluting constituents can be modeled with Polynomial Exponential Modified Gaussian (PEMG) functions. The Vivó-Truyols method first estimates the properties of each peak (i.e., peak retention time, peak width, peak height, and an optional fronting/tailing term) by analysis of the smoothed instrument output, and then the method uses these estimated values as an initial guess to further optimize the peak properties with a global optimization algorithm. The Vivó-Truyols method detects the positions (i.e., retention times) of peaks from the detected minima in the calculated second derivative of the smoothed instrument signal, after smoothing the instrument output with the Savitzy-Golay filter. The use of second derivative minima enables the method to detect peaks that are buried in signal shoulders or other signal shapes that do not necessarily feature a distinct signal maximum for each coeluting constituent. The method then estimates the width of each detected peak by analysis of several zero-crossing points and critical points in the calculated second and third derivatives of the smoothed instrument signal. The method estimates the height of each peak from the intensity of the smoothed instrument output at the estimated peak retention time. The method estimates a fronting/tailing term from the zero-crossing points and critical points of the calculated second derivative of the smoothed instrument output. The Vivó-Truyols method then further deconvolutes the detected peaks with a linear combination of PEMG functions. The method determines the parameters of the PEMG functions through a constrained optimization procedure that iteratively fits both the chromatographic signal data and its second derivative, using the previously estimated peak retention times, peak widths, peak heights, and fronting/tailing terms as an initial guess for the optimization algorithm. The Vivó-Truyols method thus attempts a global optimization of the parameters that collectively describe the retention time, width, height, and shape of each PEMG function. Vivó-Truyols and coworkers demonstrated their method with experimental liquid chromatography data containing an injected mixture of 6 standards, including up to 3 coeluting peaks, which spanned a range of peak heights that varied by <10-fold (Vivó-Truyols et al. 2005a, Vivó-Truyols et al. 2005b). The experimental chromatography data exhibited smooth shapes in the detector output, indicating a high signal-to-noise ratio for the 6 elutants.

It is unlikely that the Vivó-Truyols method would reliably interpret the second-dimension segments of a GC×GC chromatogram, which routinely contain many (e.g., >10) contiguously overlapped constituents that can vary widely in peak height (e.g., >10²-fold). The Vivó-Truyols method depends on the detection of several points within the calculated second derivatives and third derivatives of the smoothed signal, and the method additionally fits the complete second derivative of the smoothed signal during the optimization of the PEMG function parameters. However, the analysis of these high-order derivatives would be sensitive to interference from instrument noise, overlaps among numerous coelutants, and the appearance of widely differing signal intensities among the detected constituents. GC×GC is typically used to separate complex substances, which would likely confound the Vivó-Truyols method's elaborated analysis of the second and third derivatives, due to the contiguous coelutions of many (>10) constituents, widely varying peak heights (e.g., >10²-fold), and widely varying signal-to-noise ratios that arise commonly in the GC×GC second dimension. Aside from the observed signal shape, the Vivó-Truyols method does not employ additional physical considerations to constrain the width or concavity of the fitted PEMG functions, such that it could misinterpret signal features arising from coelutions in the GC×GC second dimension.

Wang and Willis (Wang and Willis 2019) developed a method to deconvolute gas chromatography-mass spectrometry data. For the one-dimensional chromatogram data of each ion detected by the MS, the method identifies as “sub-clusters” regions where a peak maximum (apex) is bounded by two minima (valleys), such that the intensities of the valley points are less than a defined fraction of the intensities of the proximate peak maxima. The method applies qualification criteria to the candidate sub-clusters. The method then applies a multivariate deconvolution to attribute the “factors” (i.e., constituents) of each ion sub-cluster, by analyzing the correlation of the ion sub-cluster with the coeluting sub-clusters of other ions. The method determines the signal profile of each deconvoluted factor by applying a multivariate curve resolution method to the set of ion sub-clusters that are attributed to the factor. The method then quantifies the factor by fitting the estimated signal profile to a theoretical peak shape, e.g., a Pearson IV curve.

The method of Wang and Willis is designed for mass spectrum datasets produced by MS, and the deconvolution method would not apply to a single-channel chromatogram data such as that produced by the single ion of an MS or that produced by an FID. The method detects constituents that exhibit maxima in the chromatogram, but it would not detect coeluting constituents which lack signal maxima and appear instead as shouldering or otherwise broadened signal shapes in the GC×GC second-dimension. The method permits the fitted ratio of peak width to peak intensity to vary by up to a factor of 9, allowing flexible interpretations of gas chromatography data. However, this assumption could lead to misinterpretation of the signal shapes produced by coeluting constituents in the GC×GC second dimension, which follow a different principle of peak spreading (see section II). Finally, the method of Wang and Willis deconvolutes spectral data based on the correlation of ion sub-clusters with the coeluting sub-clusters of other ions, but this approach may not successfully deconvolute constituents having highly similar spectra, which arises commonly among coeluting GC×GC peaks (e.g., for structurally related constituents such as isomers).

Finally, Lopatka and coworkers (Lopatka et al. 2014) developed a probabilistic peak detection method which can detect coeluting peaks in one-dimensional chromatographic data based on statistical overlap theory, but this method does not include an approach to delineate and quantify the signal associated with the detected constituents.

The above-mentioned methods for one-dimensional chromatography (Vivó-Truyols et al. 2005a, Vivó-Truyols et al. 2005b, Lopatka et al. 2014, Wang and Willis 2019) lack capabilities to address the two-dimensionality of GC×GC peaks.

### II. ADVANTAGES OF MODELING THE PEAKLET WIDTH

Various embodiments can quantitatively rationalize the observed signal of a GC×GC chromatogram that contains coeluting and/or well-separated constituents. Such embodiments can detect and quantify coelutions of many constituents that do not produce observed maxima in the second-dimension signal (such as shoulders), and which would not be detected by other techniques. By applying physical constraints to the widths and shapes of peaklets attributed to observed features in the second-dimension signal, embodiments of the present GC×GC Peak Measurement method (also referred to as “GPM method” herein) can decrease the risk of overfitting and/or misinterpreting the chromatogram data, compared with other techniques that do not impose such constraints.

The GPM method can circumvent the limitations of previous techniques by estimating the second-dimension width of a peaklet with a physical model of peaklet broadening in the GC×GC second dimension. The justification for the use of the physical model now follows.

The second dimension of GC×GC conducts a modulated, isothermal separation. Upon each modulation, trapped elutants from the first column are suddenly released into the second column. Once released from the modulator, the individual constituents then undergo separation according to their varied velocities through the second column. During this isothermal separation, all elutants move at constant velocities through the second-dimension column; therefore, slower-moving elutants exhibit a greater extent of broadening (in elution time) than faster-moving elutants. Under such conditions, the breadth of the second-dimension signal distribution of a constituent (i.e., width of a peaklet) can be related to the second-dimension retention time of that constituent, according to physical models derived from the theory of gas chromatography, such as the van Deemter equation (Grob and Barry 2004) and others (Giddings 1965). Such a model is referred to as a “physical model” herein (see TERMS).

As such, the physical model refers to an idealized model of one-dimensional peak broadening in chromatography, which assumes that the one-dimensional peak width can be estimated based on information about the elution conditions during an isothermal separation process, e.g., without apriori knowledge of the chemical identity of the constituent. Here, the physical model is employed to estimate the peaklet width parameter, o, where the peaklet represents a one-dimensional peak undergoing an isothermal separation in the second column of the GC×GC. The physical model can estimate the value of the width parameter based on information about the conditions experienced by the peaklet in the GC×GC second dimension. The parameters of the physical model can include, but are not limited to, the retention time of the peaklet and the temperature of the secondary oven.

According to one embodiment, the physical model assumes that mass transfer within the column is limited by constituent diffusion within the stationary phase, and the second-dimension broadening of a peaklet is given by:

$$σ ( {t}_{2} , T ) = \sqrt{τ ( T ) \times ( {t}_{2} - {t}_{m} )} \qquad ( 1 )$$

where σ(t₂, T) is a width parameter having units of time, t₂ is the second-dimension retention time of the constituent, tₘ is the apparent time required for the mobile phase (carrier gas) to travel through the second column, and τ(T) represents an apparent mass transfer time, which has units of time and which varies with the column temperature, T This embodiment of the physical model predicts that the peaklet has an asymmetric (skewed) Gaussian-like shape, consistent with the one-dimensional diffusion of an impulse input. Therefore, σ(t₂, T) is interpreted as the width parameter of a Gaussian-like function which represents a peaklet of the eluting constituent (FIG. 2).

In the physical model shown by Eq. 1, the apparent mass transfer time can be estimated by:

$$τ ( T ) = 8 {d}_{s}^{2} / π {D}_{s} ( T ) \qquad ( 2 )$$

where dₛ is the effective film thickness of the stationary phase, and Dₛ(T) is the apparent molecular diffusivity parameter of the constituent in the stationary phase, which depends on the column temperature (T) and the molecular properties (e.g., size, shape, polarity, torsional flexibility) of the constituent. Other embodiments of the physical model of σ be used, e.g., as described in (Giddings 1965, Grob et al. 2004), and the method is not limited thereby.

In the above embodiment of the physical model (Eqs. 1 and 2), the peaklet width parameter, σ(t₂, T), varies with temperature and with constituent identity, according to the dependence on Dₛ(T). Eq. 1 assumes that conditions are isothermal, which is satisfied on the time frame of the second-dimension separation. However, the instrument program heats both columns according to a gradual temperature ramp throughout the substance separation. The temperature of the second column may typically change by >100° C. during the course of the GC×GC separation. Therefore, the value of σ(t₂, T) generally also varies with respect to the first-dimension retention time (t₁), which spans the time frame of the GC×GC separation.

The working values of the parameters of the physical model are interpreted as apparent parameter values. The physical model of σ represents a pragmatic idealization that allows the GPM method to estimate peaklet broadening in the GC×GC second dimension. The GC×GC instrument is not designed for the purpose of making precise measurements of the parameters contained in the physical model. For example, in the embodiment represented by Eqs. 1 and 2, the working (i.e., applied) values of Dₛ(T), tₘ, and t₂ are interpreted as apparent parameter values, which can permit the estimation of σ peaklets in a GC×GC chromatogram; such apparent values are not interpreted as precise measurements of the parameters.

From a physical model of σ, such as that given by Eqs. 1 and 2, various embodiments of the GPM method can exploit several advantages, summarized below.

### A. Improving the Detection of Coeluting Constituents

The physical model of σ implies an enhancement in the sensitivity of the method used to detect coeluting constituents in the chromatogram second dimension. According to the physical model, coeluting constituents exhibit similar values of the width parameter, o, because they have proximate retention times. Consequently, the GPM method can detect the retention times of constituents by searching for minima in the second derivative of the observed profile of the second-dimension signal, because the physical model predicts that proximate constituents contribute signal shapes, which exhibit comparable degrees of concavity (as measured by the second derivative) at their second-dimension signal maxima. With this approach, the GPM method detects many coeluting constituents that do not produce maxima in the observed second-dimension signal, and which instead manifest as signal shoulders or other broadened signal features. The method thus detects more coeluting constituents than would be found by constituent detection techniques which rely only on the observed locations of signal maxima.

### B. Improving the Quantification of Coeluting Constituents

The physical model of σ further permits the GPM method to constrain the possible widths of individual peaklets with physical limits, which mitigates the risk of misinterpreting signal features. Therefore, the physical model improves the delineation of coeluting constituents, when compared with an analogous delineation approach that would lack such constraints.

### C. Improving the Efficiency and Reliability of Peaklet Optimization

Due to simplifications afforded by the physical model of σ, the GPM method can employ sequential steps to determine the second-dimension retention time (t₂), width parameter (σ), and height (h) of each peaklet within each second-dimension signal profile. The separability of these steps allows an efficient and reliable procedure for the determination of peaklet properties, for the following reasons. The physical model permits the estimation of the width parameter of a peaklet without requiring a detailed analysis of the proximate signal shape, which may be confounded by instrument noise, multiple coelutions, or widely varying signal intensities (peak heights) among the proximate coelutants.

Without the physical model, it would be necessary to devise another strategy to estimate the σ parameter for each peaklet within each second-dimension signal profile, which is a difficult data analysis problem that may give unreliable results for the following reasons. For instance, a single peaklet may be represented by a mathematical function, which accepts, e.g., three parameters to describe the shape and size of the peaklet. However, it is frequently the case that the GC×GC second dimension contains a large number (e.g., >10) of overlapping peaklets. In such cases, a large number (e.g., >3×10) of parameters must be determined in order to deconvolute these peaklets. If these parameters must be determined simultaneously (e.g., by optimization), then the optimization approach must search a parameter space containing a large number (e.g., >3×10) of dimensions, which is computationally demanding and may be intractable. Additionally, this optimization problem is typically under-determined, meaning that many different sets of parameters could reasonably explain the observed second-dimension signal data, which further obfuscates efforts to find the correct solution. Instead, the physical model allows the GPM method to determine the peaklet properties, t₂, σ and h, by a stepwise procedure that is efficient and reliable. Embodiments of the present disclosure routinely converge optimizations of >10 peaklets within a single second-dimension signal profile.

To illustrate a contrasting approach, the technique of Vivó-Truyols and coworkers (Vivó-Truyols et al. 2005a, Vivó-Truyols et al. 2005b) estimates the width of each detected peak by formulas that require the determination of several zero-crossing points and critical points of the calculated second derivative of the smoothed instrument output, as well as several zero-crossing points of the calculated third derivative of the smoothed instrument output. They demonstrated their technique for the interpretation of liquid chromatography data that featured smooth shapes in the detector output (i.e., a high signal-to-noise ratio) for a mixture of 6 injected standards, including up to 3 coeluting constituents, which varied in peak heights by <10-fold. However, the analysis of these high-order derivatives would be sensitive to interference from instrument noise, overlaps among numerous coelutants, and widely differing signal intensities among the detected constituents, such as arise in the GC×GC second dimension. Peaklets arising in the GC×GC second dimension would likely confound the Vivó-Truyols technique's elaborated interpretation of the second and third derivatives, due to signal shapes which frequently feature contiguous coelutions of many (>10) constituents, widely varying peak heights (e.g., >10²-fold), and widely varying signal-to-noise ratios among the elutants. Hence it is unlikely that the Vivó-Truyols technique would reliably estimate values σ for peaklets arising in the GC×GC second dimension.

### III. Gc×Gc Peak Measurement Method (Gpm)

The GPM method can detect constituents in the GC×GC chromatogram, and it can also delineate and quantify the signal region (“peak”) attributed to each constituent. The method can deconvolute overlapping peaks, including cases in which signal shouldering obscures the signal maxima attributed to some of the peaks. In operations, the method can detect the two-dimensional retention time positions of peaklets in a GC×GC chromatogram, e.g., by searching for maxima in the second-dimension signal and for minima in the calculated second derivative of the second-dimension signal. The method can then delineate the peak of each detected constituent, e.g., through a stepwise peak delineation procedure which determines the shape and size of the signal region attributed to the detected constituent. Each peak is composed of a set of one or more peaklets, where a single peaklet represents the signal region attributed to the peak within a second-dimension slice of the chromatogram (i.e., a second-dimension segment). Each peaklet can be represented by a parameterized peaklet shape function that has a Gaussian-like shape.

The GPM method can overcome the difficulty of deconvoluting overlapping peaks in the GC×GC chromatogram, which is the principal conundrum of interpreting GC×GC signal shapes. Previous techniques have not provided an effective solution to this problem. In the GC×GC chromatograms of many real samples, this deconvolution problem requires the simultaneous delineations of large numbers (e.g., >10) of overlapping peaklets in the GC×GC second dimension. Assuming that each of these overlapping peaklets may be represented by a parameterized mathematical function that accepts, e.g., three parameters, then this deconvolution problem implies the need to determine a large number (e.g., >3×10) of parameters. If these parameters must be optimized simultaneously, then the approach must search a parameter space having a large number (e.g., >3×10) dimensions, which is computationally demanding and which may be intractable in many cases. Additionally, the deconvolution problem is typically under-determined, meaning that many different sets of parameters could reasonably explain the observed second-dimension signal data, which impedes efforts to find the correct solution.

Unlike other techniques, the GPM method tackles the above deconvolution problem by assuming a physical model, which can estimate the peaklet width (see section II). Use of such a physical model is made possible by the isothermal separation conditions of the second GC×GC column. The physical model implies that t₂ values (second-dimension retention times) of overlapping peaklets can be detected from the curvature of the second-dimension signal profile more accurately than in a non-isothermal (e.g., temperature ramp) separation process. The physical model can also constrain the possible values of the peaklet width, which decreases considerably the volume of parameter space that is searched to determine the parameters (i.e., retention time, height, and width) of overlapping peaklets.

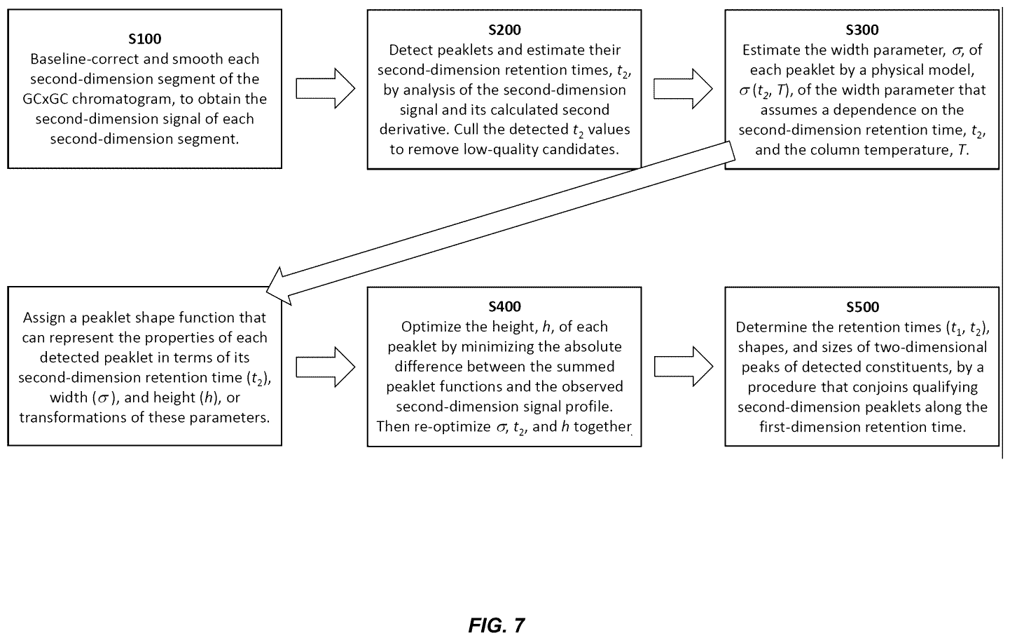

Compared to an approach lacking such a constraint, the physical model greatly reduces the problem of parameter indeterminacy, which increases the accuracy of the GPM method, because the determined peaklet widths are constrained to physically reasonable values. Finally, the physical model leads to a procedure that separates the steps for the estimation of second-dimension retention times, widths, and heights of peaklets, followed by the conjoining of peaklets into peaks (FIG. 7). The decoupling of these steps greatly decreases the dimensionality and volume of the parameter space that must be searched for the optimization of the peaklet parameters. Taken together, these simplifications lead to an approach that can efficiently and robustly detect and delineate peaks in the GC×GC chromatogram, including cases where peaks are overlapped and cases where peaks are well-separated.

### A. Generating Second-Dimension Segments of Detector Output

Embodiments can partition the raw detector output into second-dimension segments, where each second-dimension segment is defined as the second-dimension profile of detector output that spans one modulation period. The GC×GC instrument can be operated to obtain the chromatogram for a substance injected into the GC×GC instrument. During the separation of a substance by GC×GC, a single-channel detector produces a contiguous time series of discrete, quantitative measurement data. The detector conducts repeated measurements at a constant time interval, referred to as the acquisition rate. To convert the detector output into a two-dimensional chromatogram, the method partitions the detector output into second-dimension segments, such that each segment spans one modulation period. Each segment represents the second-dimension profile of detector output at a single value of the first-dimension retention time. Therefore, the acquisition rate defines the time-resolution of the second-dimension detector output, whereas the modulation period defines the time-resolution of the chromatogram first dimension. The timing of the modulations relative to the detector output may be unknown: for example, the instrument and/or acquisition software may not synchronize the modulator with the data acquisition of the detector. By shifting the segmentation of the detector output, the analyst can shift the defined zero value of the second-dimension time coordinate throughout the chromatogram. Shifting the second-dimension time coordinate is a matter of convenience, and it does not affect the results of the GPM method.

### B. Overview of the GPM Method of Detecting, Delineating, and Quantifying Peaks in GC×GC Chromatogram Data

FIG. 7 shows a flow chart of the GPM method. The description below details steps of a method for interpreting a chromatogram of single-channel data, e.g., which could represent either a GC×GC-FID chromatogram, a GC×GC-μECD chromatogram, the selected ion chromatogram of a single ion from GC×GC-MS, or the chromatogram of a summed set of ions from GC×GC-MS, or another implementation that produces the two-dimensional surface referred to as a GC×GC chromatogram.

At block S100, the GPM method estimates a baseline of the detector output data within each second-dimension segment of the chromatogram, to obtain a baseline-corrected segment (see section IV.A). As examples, the baseline can be estimated in various ways as will be appreciated by the skilled person, e.g., by applying the parameterized asymmetric least-squares warping algorithm (Eilers 2004), the dead-band baseline algorithm (Reichenbach et al. 2003), or another method to estimate the baseline. The GPM method can then smooth the baseline-corrected segment, which can be performed in various ways as will be appreciated by the skilled person, e.g., by applying a Gaussian-weighted moving average, a Savitzky-Golay filter, or another smoothing method. The baseline-corrected, smoothed output data of the segment is called the second-dimension signal. The second-dimension signal represents the portion of detector data that contains information content about eluting constituents.

At block S200, the GPM method detects the second-dimension retention times (t₂ values) of peaklets within each second-dimension segment (see section IV.B). Detecting the t₂ values of peaklets can include techniques that analyze the second-dimension signal and at least one calculated derivative (e.g., 1^{st}, 2^{nd}, or 3^{rd} derivative). In some embodiments, the t₂ values of peaklets can be detected from maxima in the second-dimension signal and from detected minima in the second derivative of the second-dimension signal, within the segment. In some implementations, the method can accept only the detected minima in the second derivative that exhibit a prominence that exceeds a minimum second-derivative prominence threshold. The minimum second-derivative prominence threshold is a function of the second-dimension signal, assigned by the analyst. Other approaches can be used to detect the t₂ values of peaklets, such as by other techniques to analyze the second-dimension signal or any one or more of its derivatives.

In some embodiments, a culling step can select (e.g., extract) acceptable t₂ values among the detected t₂ values of candidate peaklets, e.g., using qualifying criteria, which can remove low-quality or redundant candidates from further consideration (see section IV.C). For instance, according to one criterion, culling can accept the detected t₂ values where the second-dimension signal exceeds a designated minimum peaklet height threshold. According to another criterion, culling can accept the subset of t₂ values that comply with a minimum peaklet separation threshold, e.g., where the minimum peaklet separation threshold is a designated empirical function of the second-dimension retention time. Other criteria can be used for culling. Accordingly, the culling of the detected t₂ values of candidate peaklets in the segment can comprise acceptance of the detected t₂ values that meet (satisfy) one or more of the qualifying criteria.

Such a step can determine whether peaklets are present within each second-dimension segment, and if so, what are their second-dimension retention times. Later steps can resolve the positions of peaks in the first dimension.

At block S300, a width parameter is estimated for each peaklet based on a physical model of peaklet broadening in the GC×GC chromatogram (see section V.A). The physical model assumes that the width parameter of each peaklet can be estimated based on its t₂ value and the secondary oven temperature. That is, the width parameter can be specified based on the GC×GC retention time (t₁, t₂) at which the peaklet is centered.

In an embodiment, the physical model can be represented by Eqs. 1 and 2, where the parameters Dₛ and tₘ can be estimated or assigned for all peaklets in the chromatogram. The value of Dₛ can be interpolated from an empirical function of the first-dimension retention time. The second-dimension retention time position of the mobile phase, tₘ, can be estimated, e.g., from the observed modulated column bleed, which appears early in the second dimension and typically spans the first dimension. The method can adjust the σ value by a correction factor that is interpolated from an empirical function of the second-dimension signal intensity, to account for dependencies of con peaklet height that are not accounted for by the physical model, e.g., column overloading. The correction factor converges to one at low values of signal intensity.

This step can determine how wide is the second-dimension signal region associated with each peaklet in each second-dimension segment.

At block S400, the heights (h) of all peaklets within the second-dimension segment are determined by an optimization step (see section V.C). To parameterize the optimization step, the method can assign to each peaklet the previously estimated value of t₂ (block S200) and the previously estimated value of σ(block S300). The method can then optimize the peaklet heights h values within each segment by a minimization (e.g., constrained minimization) of the sum of residuals, where the “residuals” refers to the absolute difference between a sum of the peaklet shape functions and the observed second-dimension signal. Such optimizing can provide optimized peaklet heights.

To calculate a second-dimension signal profile associated with each peaklet, the peaklets can be represented by an assigned peaklet shape function (section V.B). The peaklet shape function is a mathematical function that can implement the second-dimension retention time (t₂), width (σ), and height (h) of the peaklet. In an embodiment of the peaklet shape function, the Exponentially Modified Gaussian (EMG) function can be used. The absolute difference can represent e.g., the L1 norm, absolute value, or L2 norm, difference between squared values, between the observed second-dimension signal profile and the summed peaklet shape functions. To conduct this optimization of peaklet heights, an initial guess may be used. In an embodiment, the initial guess of the height of each peaklet is assigned as the observed second-dimension signal intensity at the t₂ value of that peaklet. In another embodiment, the initial guess of the peaklet height is a fraction of the observed second-dimension signal intensity at the t₂ value of that peaklet, e.g., for cases of heavily overlapping peaklets.

The method can then adjust the peaklets by a re-optimization of the values of all three parameters, t₂, o, and h, iteratively over each peaklet, to accommodate for limitations in the physical model and other uncontrolled variations in these parameters not explained by previous steps. Accordingly, the adjustment can comprise a constrained minimization that re-optimizes the previously-determined values of t₂, σ, and h while allowing these parameter estimates to vary by a limited degree, relative to their initial values. In an embodiment, the above optimizations can employ the interior-point minimization algorithm, e.g., with constraints. Other optimization algorithms can be used. Such constraints can include (i) all peaklet heights are equal to or less than the second-dimension signal at that peaklet retention time and/or (ii) all peaklet heights are greater than zero.

This step can determine the intensity of the second-dimension signal region associated with each peaklet in each second-dimension segment.

At block S500, two-dimensional peaks are delineated by identifying associations between peaklets along the first dimension of the GC×GC chromatogram, by an analysis of the trends in height among proximate peaklets. Delineating two-dimensional peaks throughout the chromatogram can comprise of two steps. In the first step, the method can determine groups of associated peaklets, by detecting contiguously neighboring peaklets in the first dimension such that each neighboring pair exhibits a distance equal to or less than half of the minimum peaklet separation threshold in the second dimension. In the second step, the method can split each group of associated peaklets into two-dimensional peaks by iteratively analyzing a first-dimension profile of peaklet heights within the group, such that each two-dimensional peak exhibits a local maximum in the first dimension, conforms to a maximum peaklet number, and/or conforms to a minimum concavity criterion.

This step can determine where is each peak located in the first dimension, and how wide is the signal region associated with each peak in the first dimension. After this step, the GPM method can know the shape and size of the signal region associated with each peak in both chromatogram dimensions (1^{st}-D width, 2^{nd}-D width) and also know its intensity (height). This completes the delineation of the GC×GC peaks. In this manner, embodiments can quantify the signal region of the constituent associated with each GC×GC peak.

### IV. Detecting Peaklets in the Second-Dimension Signal Profile

The GPM method detects for the presence of peaklets in the second-dimension signal of each second-dimension segment, by applying several steps (FIG. 7). In a first step, the method can estimate a baseline of each second-dimension segment, which represents the systematic portion of the detector output that is attributed to non-constituent origins (block S100). Removal of the baseline from the detector output produces baseline-corrected segment data. The method can then smooth the baseline-corrected segment data, which removes uncontrolled variations attributed to instrument noise (block S100). The smoothed, baseline-corrected segment data is referred to as the second-dimension signal, which represents the signal structure attributed to eluting constituents.

To detect for the presence of peaklets within each second-dimension segment, the method analyzes the second-dimension signal and its calculated derivatives (block S200). As an example, the method can detect second-dimension retention time (t₂) values of candidate peaklets, e.g., by searching for the presence of maxima in the second-dimension signal, and by searching for the presence of minima in the calculated second derivative of the second-dimensional signal. To remove low-quality or redundant candidates, the method can cull the detected t₂ values of candidate peaklets, by accepting only those candidates that meet one or more qualifying criteria. For example, the method can accept only the t₂ values where the second-dimension signal exceeds a minimum peaklet height threshold, which is a parameter designated by the analyst. The method can accept only the t₂ values that comply with a minimum peaklet separation threshold, where the minimum peaklet separation threshold can be a function of the second-dimension retention time that is designated by the analyst.

These and other embodiments are further explained in the next sections (IV.A, IV.B, IV.C).

### A. Determining the Baseline and Smoothing the Detector Output

The GPM method estimates a baseline of the detector output data within each second-dimension segment of the chromatogram, to obtain a baseline-corrected segment (block S100). The baseline represents an estimate of systematic bias or low-frequency drift that may appear in the raw detector output, attributed to non-constituent origins. The baseline may also capture prolonged low-lying tails of GC×GC peaklets that are not easily represented by the peaklet shape function. The baseline-corrected segment data refer to the detector output of the second-dimension segment minus the baseline. In an embodiment, the GPM method estimates the baseline of the second-dimension segment with a parameterized asymmetric least-squares warping algorithm (Eilers 2004). In another embodiment, the dead-band baseline algorithm of Reichenbach and coworkers (Reichenbach et al. 2003) may be employed to estimate the baseline of the second-dimension segment. Other algorithm parameters or baseline detection methods may be used to obtain the baseline-corrected segment data, and embodiments of the invention are not limited thereby.

The GPM method can then smooth each baseline-corrected segment, to obtain the second-dimension signal (block S100). By the application of smoothing, the method aims to remove instrument noise from the baseline-corrected segment data, while preserving the signal structure attributed to eluting constituents. In an embodiment, the GPM method applies a Gaussian-weighted moving average with a fixed window length to smooth the baseline-corrected segment, employing a window size or sizes selected by the analyst. For the purposes of detecting the t₂ values of candidate peaklets (section IV.B), the method may apply a differing smoothing window length to signal features of widely differing intensity, because instrument noise may affect these cases differently. In another embodiment, the instrument noise may be attenuated with a Savitzky-Golay filter, or with a low-pass filter. In another embodiment, the smoothing step may apply a tailored moving average window or a tailored filter, for example if a power spectrum analysis would show that the instrument noise is dominated by particular frequencies. Other methods may be employed to smooth the baseline-corrected segment, and the invention is not limited thereby.

The baseline-corrected, smoothed segment is referred to as the second-dimension signal. The second-dimension signal represents the portion of detector output that is attributed to eluting constituents, with reduced interference from instrument noise and instrument detector bias.

### B. Detecting Candidate Peaklets in Each Second-Dimension Segment

Embodiments of the GPM method can search for detectable constituents in each second-dimension segment by analysis of the second-dimension signal and its calculated derivatives (block S200). The second-dimension retention times (t₂) of candidate peaklets can be detected from critical points in second-dimension signal and its calculated second derivative. Using the signal data from the previous step, embodiments can calculate the second derivative of the second-dimension signal. As examples, the t₂ values of candidate peaklets can be detected by two criteria: (a) the retention times of detected local maxima in the second-dimension signal; and (b) the retention times of detected local minima in the calculated second derivative of the second-dimension signal. As an example, the second derivative can be calculated using a Savitzky-Golay filter. Other algorithms could be used to calculate the second derivative, and the invention is not limited thereby

To avoid spurious detections, some embodiments can accept only those second-derivative minima exhibiting a prominence value that exceeds a minimum second-derivative prominence threshold. Here, the prominence of a function minimum is defined as the lowest rise in the function value, relative to that minimum, which must be traversed to arrive at function values lower than the minimum. The minimum second-derivative prominence threshold can be represented as a function of the intensity of the second-dimension signal: at the apex of a peaklet, the magnitude of the calculated second-derivative of second-dimensional signal (attributed to the peaklet) is expected to scale with peaklet height, at a given t₂ value (which constrains σ). The function that represents the minimum second-derivative prominence threshold is assigned by the analyst. For example, the assigned function can determine the minimum second-derivative prominence threshold as a linear function of the second-dimensional signal, or as a polynomial function of the second-dimensional signal.

Local minima in the second derivative represent concave-down locations where the second-dimension signal concavity reaches a local maximum, indicative of the rapid signal fluctuation attributable to the apex of an individual eluting constituent. In this way, the embodiment can detect more candidate peaklets than would be found by consideration of the observed maxima (apices) in the second-dimension signal alone, because coeluting constituents often obscure signal maxima that would otherwise be observed for the same constituents when resolved individually. For example, the appearance of a shoulder in a second-dimension signal peak may demonstrate the presence of a coeluting constituent without exhibiting an associated signal maximum. However, the local maxima in the original second-dimension signal are also important. Compared with the local minima in the second derivative, the local maxima in the second-dimension signal can provide improved estimates of t₂ values of candidate peaklets in some cases. Therefore, both approaches are applied to detect t₂ values of candidate peaklets in the second-dimension segment. By choosing from critical points in both the original second-dimension signal and its second derivative, the embodiment is more robust to cases where one approach may fail due to interference from noise.

In a later step, the method can further adjust the detected t₂ values of peaklets by a constrained re-optimization of the parameters, σ, t₂, and h, iteratively over each peaklet, after the parameters σ and h have been determined, to accommodate for uncontrolled variability in these parameters that is not adequately explained by other steps (block S400; see section V.C).

In another embodiment, a multi-pass procedure can be applied to detect additional t₂ values of candidate peaklets in the second-dimension segment. After the peaklets in a segment have been fitted by a first pass that follows all of the steps up through the optimization of peaklet properties (blocks S300 and S400), the residual signal of the segment can be searched for additional t₂ values of candidate peaklets that were not detected by the first pass. In the second pass, the additional t₂ values would be detected as local maxima in the residual signal.

For the purposes of detecting second-dimension retention times of candidate peaklets in the second-dimension segment, other data analysis approaches may be employed, and embodiments of the present disclosure are not limited thereby.

### C. Culling the Detected Second-Dimension Retention Times of Candidate Peaklets

The GPM method can cull the detected t₂ values of candidate peaklets in the second-dimension segment, according to qualifying criteria. In an embodiment, with the detected t₂ values of candidate peaklets obtained in the previous step, a method can omit consideration of candidate peaklets where the second-dimension signal falls below a designated minimum value, referred to as the minimum peaklet height threshold, to avoid misinterpreting spurious signal features as separable constituents. The analyst chooses the value of the minimum peaklet height threshold.

Among the candidate peaklets that exceed the minimum peaklet height threshold, the method can select a subset such that the peaklet t₂ values are mutually separated by a distance value referred to as a minimum peaklet separation threshold. The minimum peaklet separation threshold represents the limit of detectable separability among peaklet positions in the GC×GC second dimension.

In an embodiment, the method selects the detected t₂ values that exhibit a separation distance greater than or equal to the minimum peaklet separation threshold. The method can further select the detected t₂ values that exhibits the highest second-dimension signal intensity (also referred to as highest signal intensity), among any subset of detected t₂ values that exhibit a separation distance less than the minimum peaklet separation threshold.

The implemented minimum peaklet separation threshold can vary with respect to second-dimension retention time in the segment, consistent with the broadening of constituent elution with increasing second-dimension retention time. In a preferred embodiment, the method can interpolate values of the minimum peaklet separation threshold from an empirical function of second-dimension retention time; the empirical function can be assigned by the analyst. Examples of the empirical function include, and are not limited to: a linear function of second-dimension retention time, a polynomial function of second-dimension retention time, or a numerical interpolation at varied second-dimension retention times. The minimum separation distance may be implemented as a value of time, peaklet width, or other function of time, and the invention is not limited thereby.

Other criteria may be employed to cull the detected t₂ values of candidate peaklets in the segment, and embodiments of the present disclosure are not limited thereby.

### V. Determining the Widths, Shape, and Heights of Peaklets

As described above, the GPM method can detect peaklets and also determine their retention time (t₁, t₂) locations in the GC×GC chromatogram, by determining the second-dimension retention time (t₂) values of all peaklets in each second-dimension segment, where each segment has a known first-dimension retention time (t₁). To complete the characterization of peaklets, the method additionally determines the width parameter (σ), shape, and height (h) of each peaklet. The width of each peaklet is determined by application of the physical model (section II). This is followed by the assignment of a peaklet shape function, which is a mathematical function that can describe the size and shape of each peaklet. The peaklet shape function can accept as input the parameters t₂, σ, and h, or transformations of these parameters.

To determine the height (h) of each peaklet, the method can optimize the values of h over the peaklets in each segment, where the each peaklet is represented by the shape function with previously determined values of t₂ and σ. The method can then adjust the values of all three parameters, t₂, σ, and h, by an iterative re-optimization of each peaklet, to account for limitations of the previous steps, e.g., the physical model. Finally, the method can cull the optimized peaklets, by accepting only those peaklets that comply with qualifying criteria, e.g., based on the minimum peaklet height threshold and the minimum peaklet separation threshold.

### A. Determining the Widths of the Peaklets

Given the culled retention time positions of detectable constituents in the second-dimension segment from the previous step, the GPM method estimates a σ value of each peaklet using the physical model of the peaklet width (block S300). The physical model approximates the peak broadening that occurs in the isothermal separation of the GC×GC second column, which differs from the peak broadening that occurs under the temperature ramp conditions of a conventional one-dimensional gas chromatography separation. With a physical model to estimate the σ value, the method assigns the width values for all peaklets throughout the segment. By imposing physical constraints on the magnitude of σ, the method reduces the risk of misinterpreting overly-broad signal features as single constituents.

According to the physical model, the σ values of peaklets can vary with both first-dimension retention time and second-dimension retention time. The σ values vary in the GC×GC second dimension because the physical model describes the time-dependent peak-broadening process that occurs during the second-dimension separation. The σ values also vary in the GC×GC first dimension, because the temperature of the secondary oven varies throughout the first-dimension separation process. The parameters of the physical model, e.g., diffusivity, are assumed to depend on the temperature of the secondary oven. Therefore, the GPM method can parameterize the physical model in a way that accounts for the variation of σ values in both the second dimension and the first dimension of the GC×GC chromatogram.

In an embodiment of the physical model of c, Eqs. 1 and 2 are applied, where the value of apparent diffusivity (Dₛ) is interpolated from an empirical function of the first-dimension retention time. Examples of the empirical function include, and are not limited to: a linear function of first-dimension retention time, a polynomial function of first-dimension retention time, or a numerical interpolation at varied first-dimension retention times. The Dₛ value varies with first-dimension retention time to account for the gradually increasing column temperature throughout the GC×GC separation. To determine the empirical function of Dₛ values for a given instrument program, the analyst may determine function values that can accurately reproduce the signal shapes of both well-separated and coeluting peaklets in the GC×GC chromatogram, by conducting trials of varied Dₛ values for several different second-dimension segments at varied first-retention time values.

In another embodiment, the analyst may evaluate the fitted σ values of measured standards of pure compounds which produce peaklets of well-separated constituents at varied retention time positions in the chromatogram. The second-dimension retention time position of the mobile phase, tₘ, can be estimated from the observed modulated column bleed, which appears early in the second dimension and typically spans the first dimension. In another embodiment, tₘ can be extrapolated from the width of the column bleed feature, based on the observed trends in peaklet widths in the segment. In another embodiment, the tₘ parameter can be determined by other experimental or theoretical means, e.g., as in (Klee and Blumberg 2010).

In other embodiments, the physical model of σ can be derived from additional terms in extended or modified forms of the van Deemter equation (Grob and Barry 2004), or other mass transfer models from gas chromatography theory, e.g., (Giddings 1965). For example, the physical model can assume that the release of modulated constituents is not instantaneous. In this embodiment, the physical model can include a term that represents the initial width of the distribution of a modulated constituent (in units of time) as it leaves the modulator, which can be estimated e.g., from the observed width of the column bleed feature. In another embodiment, the physical model can account for differences in diffusivity that depend on the constituent chemical structure, if the analyst possesses apriori information about the chemical identities of the constituents. In other embodiments, the physical model can incorporate mixed mass transfer (e.g., partition/adsorption) mechanisms, other expressions to represent diffusion processes in either the stationary phase or mobile phase (i.e., carrier gas), or other physical considerations as discussed in gas chromatography theory, e.g., (Giddings 1965).

With the σ values of peaklets that are estimated by the physical model, the GPM method can adjust the σ values slightly for individual peaklets, to accommodate for limitations in the physical model. This can include dependencies of con peaklet height that are not accounted for by the physical model, e.g., column overloading by high-abundance constituents, and uncontrolled variations in the diffusivity parameter, Dₛ, that depend on molecular properties (e.g., size, shape, polarity, torsional flexibility) which can vary from constituent to constituent. For example, the method can adjust the σ value by a correction factor that is interpolated from an empirical function of the signal intensity. Examples of the empirical function include and are not limited to: a linear function of signal intensity, a polynomial function of signal intensity, a logarithmic function of signal intensity, or a numerical interpolation at varied signal intensities. The correction factor converges to one at low values of signal intensity. Additionally, in a later step, the method can further adjust the σ value by a constrained re-optimization of the parameters, σ, t₂, and h, iteratively over each peaklet, after the h parameter has been determined (see section V.C), which can accommodate for uncontrolled variations in these parameters that are not explained by other steps.

Additional physical models or approximations may be employed to determine the value of u or D, and the invention is not limited thereby.

### B. Choosing the Peaklet Shape Function

The GPM method represents the shape of each peaklet with a peak shape function, which is a mathematical function that resembles the observed shape of second-dimension signal features produced by well-separated constituents throughout a chromatogram.

In some embodiments, the peaklet shape is represented by an Exponentially Modified Gaussian (EMG) function. EMG functions have been used previously to describe chromatographic peaks (Di Marco and Bombi 2001). An EMG function represents the probabilistic distribution that is given by a Gaussian (i.e., diffusion-like) distribution mixed with an exponential decay distribution. An EMG function can be characterized by three parameters: the mean (ρEMG) of the Gaussian component, the standard deviation (σEMG) of the Gaussian component, and the characteristic decay time (τEMG) of the exponential component. In the embodiment, the width of a peaklet, σ, is taken as equivalent to the σEMG parameter; the second-dimension retention time (t₂) of a peaklet can be obtained from transformations of μEMG, σEMG, and τEMG; and the height of a peaklet (h) can be obtained from the maximum value of the parametrized EMG function, including the applied coefficient (i.e., amplitude). The characteristic decay time, τEMG, can be determined as follows. A skew parameter can be defined by the ratio, τEMG/σEMG. Assuming that peaklets within a second-dimension segment exhibit comparable values of the skew parameter, the method can interpolate the skew parameter from an empirical function of the first-dimension retention time; the empirical function can be assigned by the analyst. For example, the skew parameter can be represented as a linear function or polynomial of the first-dimension retention time, or the skew parameter can be numerically interpolated from assigned values that span the first-dimension retention time. In this way, the skew parameter can be assigned to peaklets throughout the chromatogram. By assigning the skew parameter throughout the chromatogram, the method constrains the value of τEMG for each peaklet, once the value of σEMG has been determined for that peaklet.

In another embodiment, the peaklet shape function represents the leading front of the peaklet, up to the apex, with a Gaussian function centered at the peaklet retention time and having a width parameter given by u. In the embodiment, the method represents the trailing portion of the peaklet, after the apex, with a Gaussian function centered at the peaklet retention time and having the same width parameter, but calculated on a substituted coordinate. The substituted coordinate is given by the difference of second-dimension retention time from the peaklet retention time, raised to a power given by a constant ≤1, referred to as the skew parameter. With a skew parameter value set to 1, this embodiment produces a true Gaussian with no skew. In this embodiment, the peaklet shape function assumes that the leading front of the eluting constituent (before the peaklet apex) is broadened by a diffusion process, consistent with the isothermal separation conditions of the GC×GC second column. The peaklet shape function assumes that the trailing portion of the eluting constituent (after the peaklet apex) is broadened by a non-linear desorption process, which produces tailing and skews the peaklet shape. The analyst can calibrate the skew parameter to adjust the extent of peaklet tailing, so that the tailing is consistent with observations produced by a particular instrument program.

In other embodiments, other functions or approximations may be employed to represent the peaklet shape, such as a Gaussian function, a skewed Gaussian function, a log-normal function, a PEMG function, a Pearson IV function, other chromatography peak functions (Di Marco and Bombi 2001), or other functions, and the invention is not limited thereby.

### C. Optimizing the Heights of Peaklets

The GPM method determines the heights of peaklets in each second-dimension segment by an optimization step, as follows (block S400). Given the t₂ values of detected peaklets (after culling) from the previous step (section IV), the method calculates an initial guess of the height of each peaklet. In an embodiment, the initial guess of the peaklet height is the observed second-dimension signal intensity at the t₂ value of that peaklet. In another embodiment, the initial guess of the peaklet height is a fraction of the observed second-dimension signal intensity at the t₂ value of that peaklet, e.g., for cases of heavily overlapping peaklets. The method can relate the peaklet height to the other peaklet properties in accordance with the mathematical function that was chosen for the peaklet shape. For example, in the case of a Gaussian function, the peaklet shape height can be determined from:

$${h}_{G a u s s i a n} = \frac{{α}_{G a u s s i a n}}{( \sqrt{2 π} ) {σ}_{G a u s s i a n}} \qquad ( 3 )$$

where h_{Gaussian} represents the height (maximum value) of the Gaussian function, α_{Gaussian} represents the coefficient multiplied to the Gaussian function (i.e., the amplitude), and σ_{Gaussian} represents the peak width parameter of the Gaussian function.

In this optimization step, each peaklet is represented by the assigned peaklet shape function (section V.B), where the peaklet shape function is parameterized using the previously estimated value of t₂ (block S200), the previously estimated value of σ(block S300), and the initial guess for h. After calculating the initial guess, the GPM method can optimize the heights of the peaklet in the segment, e.g., by a constrained minimization of the sum of the residuals, where the “residuals” refers to the absolute difference between the sum of the peaklet shape functions and the observed second-dimension signal. Embodiments can represent the absolute difference as e.g., the L1 norm, absolute value, or L2 norm, difference between squared values. The minimization can constrain the optimized values of h to account for physical considerations, e.g., the constraints can limit the optimization to solutions that have h≥0 (i.e., non-negative) and h≤ the observed second-dimension signal height at the t₂ value of the peaklet, for all peaklets. In some embodiments, the absolute difference can apply non-uniform weighting to the second-dimension signal. For example, non-uniform weighting can reflect an assumption that the second-dimension signal contains the most reliable information content near the locations where peaklets have been detected, e.g., with higher weighting applied to parts of the second-dimension signal that are most proximate to the t₂ values of detected peaklets.

After the h parameter has been determined, the GPM method can further adjust the values of σ, t₂, and h by a constrained re-optimization of all three parameters together, iteratively over each peaklet (e.g., analogous to previously reported methods (Di Marco and Bombi 2001, Vivó-Truyols et al. 2005b)). The re-optimization of σ, t₂, and h can comprise a constrained minimization of an absolute difference (e.g., L1 norm, absolute value, or L2 norm, difference between squared values) between the observed second-dimension signal profile and the summed peaklet shape functions.

The re-optimization step is justified by the known limitations of the previous steps of the GPM method, and it can accommodate for uncontrolled variations in the peaklet parameters that are not explained by other steps. For example, the σ parameter can vary slightly among peaklets in ways that are not accounted for by the physical model, e.g., due to variations in diffusion behaviors of different constituents arising from variations in their molecular properties (e.g., size, shape, polarity, torsional flexibility). The previously estimated t₂ value of each peaklet may exhibit slightly inaccuracy due to nuances in the second-dimension signal that are not perfectly captured by the steps described in section IV, e.g., such as signal bias introduced by smoothing. With these considerations in mind, the re-optimization can include constraints on the optimized values of σ, t₂, and h which allow these parameter estimates to vary by a limited degree, relative to their initial values. For example, the constraints can limit the percentages by which the values of σ, t₂, and h are allowed to change during the re-optimization, relative to the initial values, for each peaklet. The constraints can additionally limit the optimization to physically reasonable solutions, e.g., those having h≥0 (i.e., non-negative) and h≤ the observed second-dimension signal height at the t₂ value of the peaklet, for all peaklets. In this way, the peaklets can be re-optimized to provide a more accurate description of the second-dimension signal without overfitting the signal. These slight adjustments to σ, t₂, and h do not undermine the assumptions of the physical model (section II) or the earlier signal interpretation (section IV).

The GPM method can apply various algorithms to perform the constrained optimization steps described above. In an embodiment, the method can employ the interior-point minimization algorithm. In another embodiment, these constrained optimizations can employ the sequential quadratic programming method. In another embodiment, the constrained optimizations can employ the active-set method. Other methods and criteria may be used to optimize the peaklet heights, widths, and retention times, and the invention is not limited thereby.

After the peaklets have been optimized, the method can cull the peaklets to accept only those peaklets that satisfy qualifying criteria. In an embodiment, the culling step accepts any peaklet having a height above the minimum peaklet height threshold and any peaklet that lies beyond a distance of a more intense peak that is less than the minimum peaklet separation threshold. After culling, which can remove some peaklets, the previous optimizations of h, σ, and t₂ can be re-applied in a multi-pass procedure, so that the retained peaklet shape functions can be re-determined. Additional criteria may be used to cull the optimized peaklets, and the invention is not limited thereby.

Therefore, the optimization step can find the set of peaklet parameters that permit the calculated peaklets to explain the observed second-dimension signal without overfitting, according to the implemented optimization criteria. The explained signal is defined as the summed peaklet functions that have been optimized by the current procedure. This approach is able to rationalize the observed second-dimension signal with up to a large number (e.g., >10) of overlapping and/or well-separated peaklets throughout a second-dimension segment.

### VI. Delineating Two-Dimensional Peaks

The GPM method delineates two-dimensional chromatogram peaks by identifying associations between peaklets along the first dimension of the GC×GC chromatogram (block S500), within the following considerations. The time-resolution of the chromatogram first dimension is defined by the modulation period, which is a much longer time interval than the time-resolution of the chromatogram second dimension (defined by the detector acquisition rate). Therefore, the first-dimension signal profile of a well-separated constituent contains relatively few (typically, 1 to 3) peaklets, depending on the characteristic first-dimension widths of two-dimensional peaks in the chromatogram. Given the set of optimized and culled second-dimension peaklets from the previous step (section V), the method delineates two-dimensional peaks by identifying associations between peaklets throughout the first dimension of the GC×GC chromatogram, by an iterative analysis of the height trends among proximate peaklets.

In an embodiment, the method first assigns every peaklet in the chromatogram to a group of associated peaklets, as follows. Each group of associated peaklets contains a set of contiguously neighboring peaklets in the first dimension of the chromatogram, such that each peaklet within the group is proximate to adjacent first-dimension neighbors by a second-dimension distance that is equal to or less than half of the minimum peaklet separation threshold. For example, each neighboring pair in the group can exhibit a separation distance (in the second dimension) equal to or less than half of the minimum peaklet separation threshold. Therefore, the approach assumes that the adjacent peaklets within a two-dimensional peak exhibit a second-dimension separation distance that is within half of the minimum peaklet separation threshold.

The grouping of associated peaklets can account for the gradual increase in secondary oven temperature with increasing first-dimension retention time, which influences the t₂ values of associated peaklets within a group. In the calculation of the second-dimension distances between a peaklet and its adjacent first-dimension neighbors, the distance can be adjusted by a factor which accounts for the slight dependence of the peaklet t₂ value on temperature, e.g., using relationships established by (Arey et al. 2005). This factor accounts for the common observation that the peaklets within a constituent peak exhibit a slight but systematic shift to lower t₂ values with respect to increasing first-dimension retention time.

Within each group of associated peaklets, the embodiment then assigns peaklets to two-dimensional peaks according to the following criteria. Among groups containing 1 or 2 peaklets, the method assigns each group to a single distinct peak. Among groups containing 3 or more peaklets, the method can conduct an iterative analysis of the peaklets within the group, according to the following criteria. (i) The method evaluates the first-dimension profile of peaklet heights within the group, and it assigns each local maximum to a distinct peak. (ii) Among the remaining peaklets in the group, the method iteratively evaluates the peaklets by descending order of peaklet height. (iii) If the evaluated peaklet is neighbored by a higher peaklet and a lower peaklet, the method assigns the evaluated peaklet to the same peak as the higher peaklet. (iv) If the evaluated peaklet is neighbored by two higher peaklets, the method assigns the evaluated peaklet as a border peaklet, which defines that peaklet as unassociated to any peak. (v) If the evaluated peaklet is neighbored by one higher peaklet, the method assigns the evaluated peaklet to the same peak as the higher peaklet. (vi) If the evaluated peaklet is neighbored by only border peaklets, then the method assigns the evaluated peaklet as a border peaklet. (vii) During the iterative evaluation of peaklets, the method may potentially populate each peak up to a maximum peaklet number, which is a parameter that represents the maximum number of allowed peaklets within a peak. In the embodiment, the maximum peaklet number is 3. (viii) During the iterative evaluation of peaklets, the method can require that each peak containing three peaklets must conform to a minimum concavity criterion which constrains the peak shape in the first dimension; if the criterion is not met, the method iteratively reassigns the least-conforming peaklet as a border peaklet until the criterion is met. Other methods may be used to determine groups of associated peaklets and split these groups into distinct two-dimensional peaks, and the invention is not limited thereby.

Results of the GPM method are shown for four GC×GC chromatograms which represent the separations of three different complex substances by four different GC×GC instrument configurations, employing four different detectors (FIGS. 8A-15). This dataset of real samples poses a diversity of realistic challenges to the interpretation of GC×GC chromatograms. The dataset spans a wide range of sample compositions, instrument configurations, instrument programs, chromatogram resolutions, and levels of analyst experience. The presented results demonstrate that the GPM method can successfully detect and delineate peaks in all of these GC×GC chromatograms, revealing the efficiency and robustness of the method.

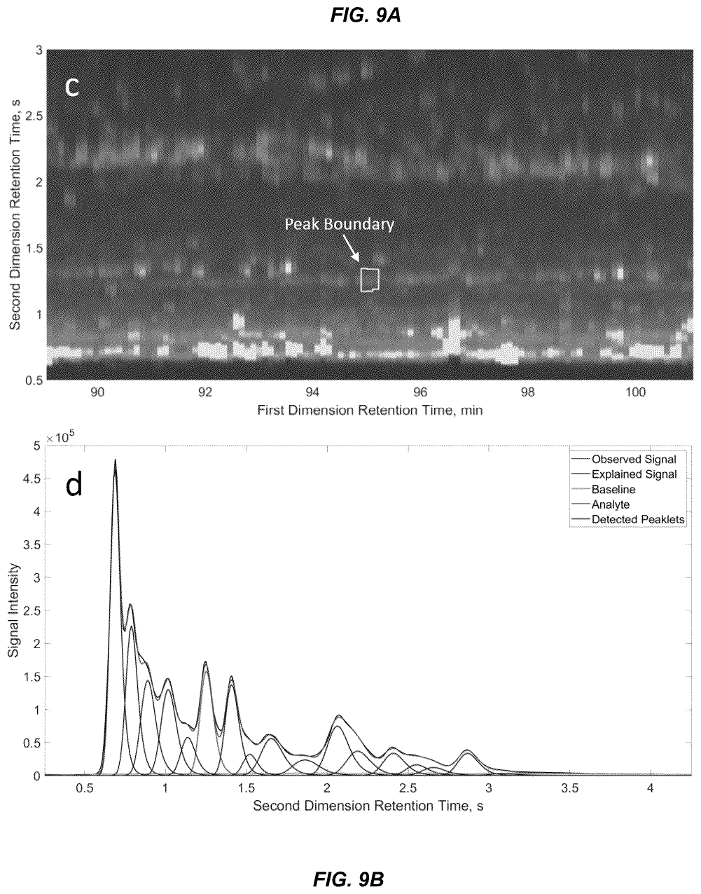

FIGS. 8A-8B and 9A-9B illustrate the results of a delineation of a single peak (“analyte”) centered at 95.008 min (first dimension) and 1.25 s (second dimension) in the GC×GC-FID chromatogram of a crude oil shown in FIG. 3. FIGS. 8A-8B and 9B display various representations of the chromatogram signal (vertical axis) versus the second-dimension retention time (horizontal axis) of the second-dimension segments containing the delineated analyte which is centered at 95.008 min and 1.25 s. Plotted are the observed detector output (black), the estimated baseline (green), the optimized peaklets (blue), and the explained second-dimension signal plus baseline (red). The peaklets of the delineated analyte are displayed in pink. In panel a, labels annotate an example of a local signal maximum in the segment, as well as a region where the signal exhibits shouldering, indicative of a coeluting constituent that does not display a signal maximum. FIG. 9A illustrates a heat map of the region of the chromatogram containing the delineated analyte which is centered at 95.008 min and 1.25 s. The approximate boundaries of the delineated analyte are shown by a white-outline polygon.

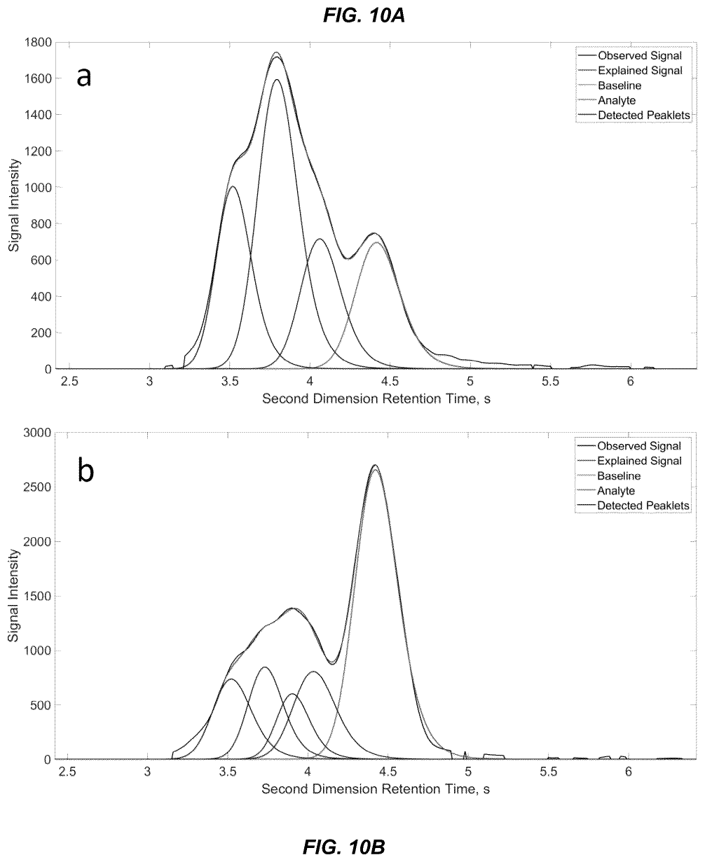

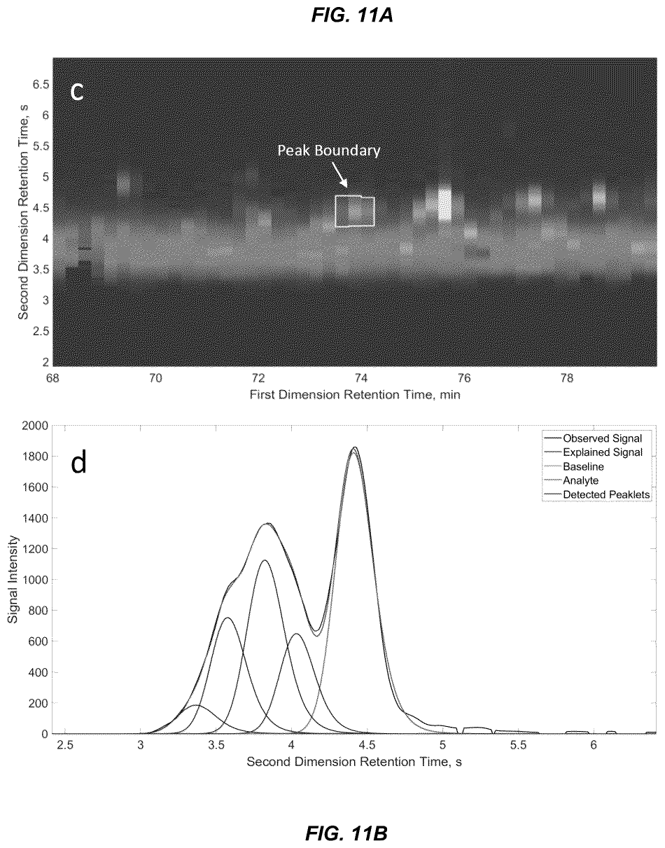

FIGS. 10A-10B and 11A-11B illustrate the results of a delineation of a single peak (“analyte”) centered at 73.750 min (first dimension) and 4.42 s (second dimension) in the chromatogram of the ion with a mass of 137.1325 Daltons, from the separation of a crude oil by GC×GC-EI-HR-TOFMS shown in FIG. 4. FIGS. 10A-10B and 11B display various representations of the chromatogram signal (vertical axis) versus the second-dimension retention time (horizontal axis) of the second-dimension segments containing the delineated analyte which is centered at 73.750 min and 4.42 s. Plotted are the observed detector output (black), the estimated baseline (green), the optimized peaklets (blue), and the explained second-dimension signal plus baseline (red). The peaklets of the delineated analyte are displayed in pink. FIG. 11A illustrates a heat map of the region of the chromatogram containing the delineated analyte which is centered at 73.750 min and 4.42 s. The approximate boundaries of the delineated analyte are shown by a white-outline polygon.

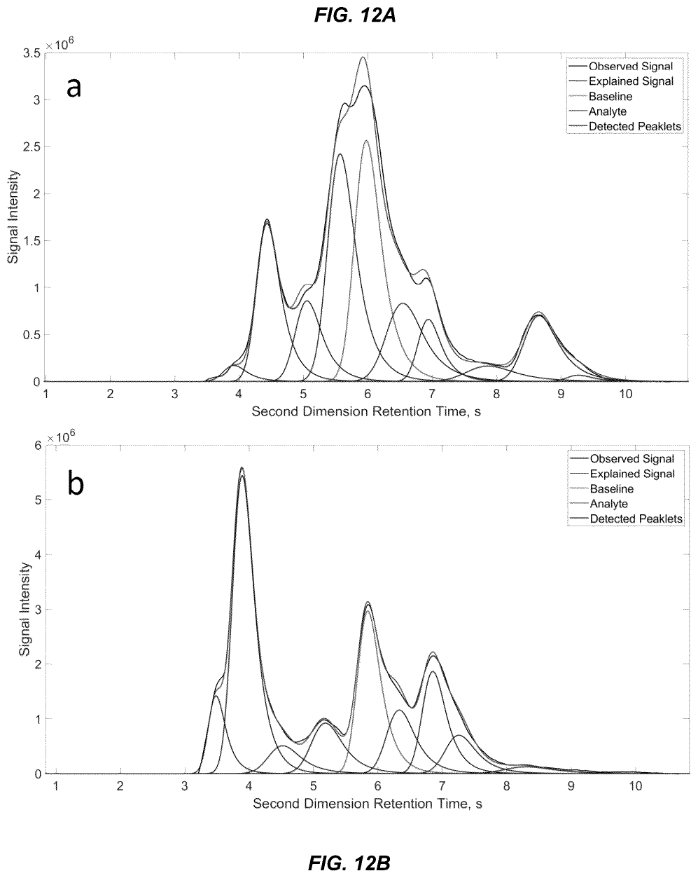

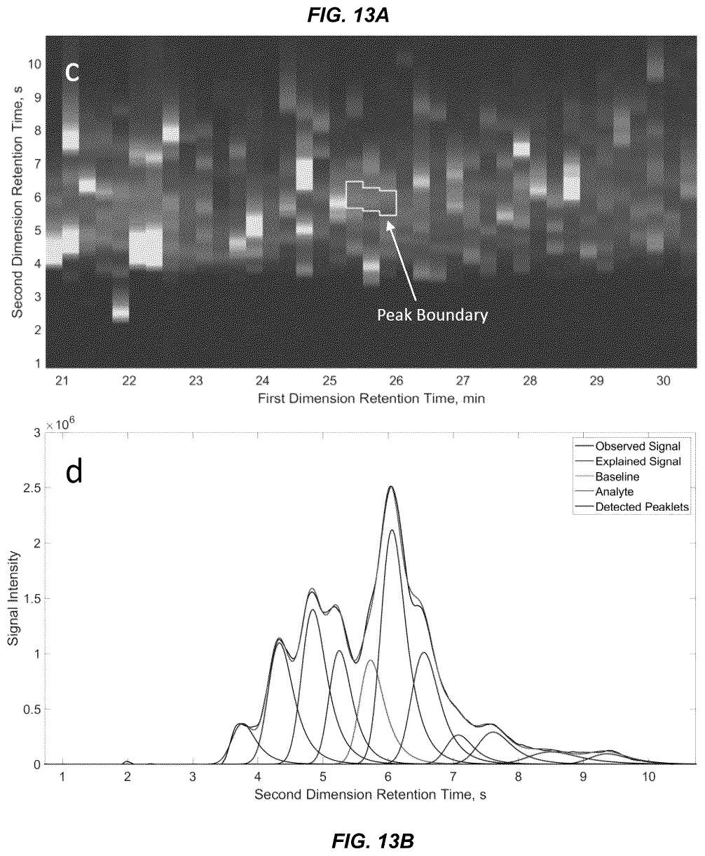

FIGS. 12A-12B and 13A-13 illustrate the results of a delineation of a single peak (“analyte”) centered at 25.750 min (first dimension) and 5.73 s (second dimension) in the GC×GC-μECD chromatogram of a wastewater extract shown in FIG. 5. FIGS. 12A-12B and 13B display various representations of the chromatogram signal (vertical axis) versus the second-dimension retention time (horizontal axis) of the second-dimension segments containing the delineated analyte which is centered at 25.750 min and 5.73 s. Plotted are the observed detector output (black), the estimated baseline (green), the optimized peaklets (blue), and the explained second-dimension signal plus baseline (red). The peaklets of the delineated analyte are displayed in pink. FIG. 13A illustrates a heat map of the region of the chromatogram containing the delineated analyte which is centered at 25.750 min and 5.73 s. The approximate boundaries of the delineated analyte are shown by a white-outline polygon.

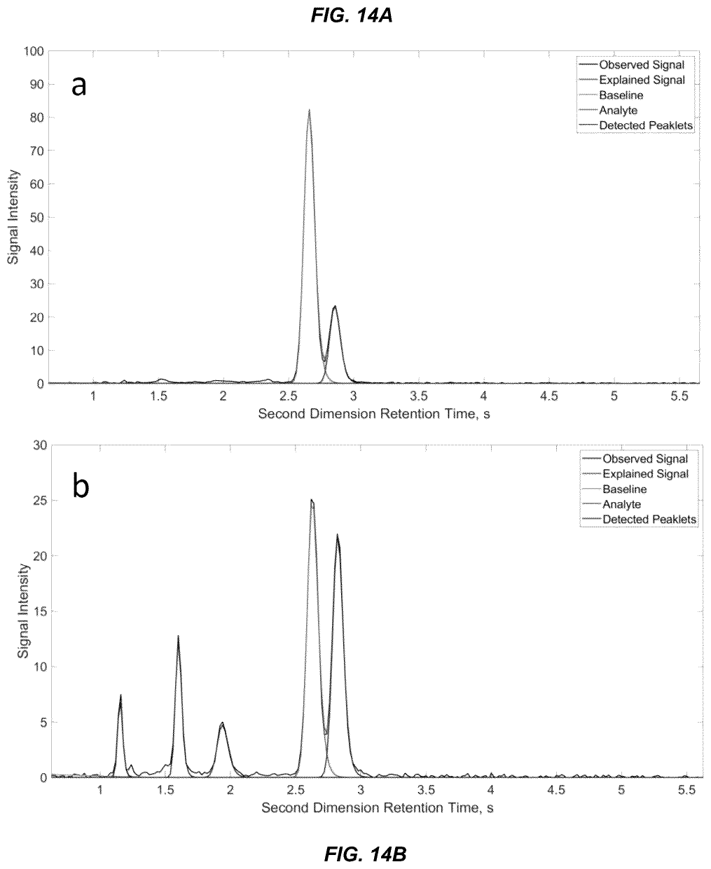

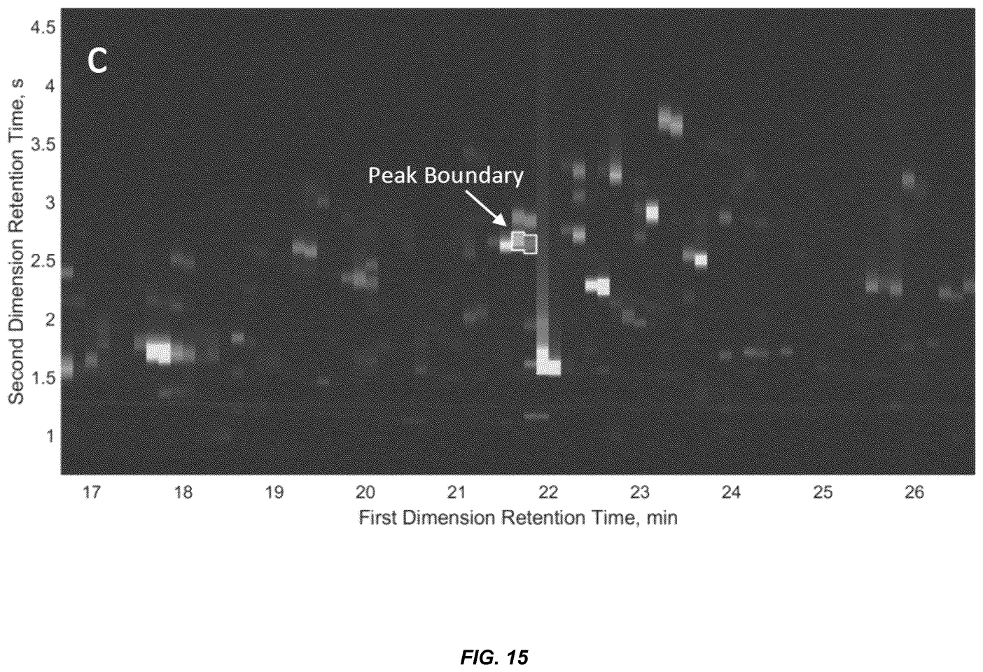

FIGS. 14A-14B and 15 illustrate the results of a delineation of a single peak (“analyte”) centered at 21.600 min (first dimension) and 2.66 s (second dimension) in the total ion chromatogram of a GC×GC-ENCI-TOFMS separation of a lake water extract shown in FIG. 6. FIGS. 14A-14B display various representations of the chromatogram signal (vertical axis) versus the second-dimension retention time (horizontal axis) of the second-dimension segments containing the delineated analyte which is centered at 21.600 min and 2.66 s. Plotted are the observed detector output (black), the estimated baseline (green), the optimized peaklets (blue), and the explained second-dimension signal plus baseline (red). The peaklets of the delineated analyte are displayed in pink. FIG. 15 illustrates a heat map of the region of the chromatogram containing the delineated analyte which is centered at 21.600 min and 2.66 s. The approximate boundaries of the delineated analyte are shown by a white-outline polygon.

### VII. Measuring Peaks in Spectral Chromatograms

Compared with single-channel data (e.g., GC×GC-FID, GC×GC-ECD), spectral data offer greater degrees of freedom to deconvolute and differentiate coeluting constituents.

The preceding sub-sections explain peak measurement for single-channel chromatograms. The following section explain peak measurement for spectral chromatograms, such as from GC×GC-MS. Whereas single-channel detectors support efforts to determine occurrence and quantification of the separated constituents, spectral detectors additionally support efforts to interpret the chemical identities of the separated constituents. The method includes approaches to support the interpretation of chemical identity in spectral chromatograms, including non-target analysis, suspect analysis, and target analysis. These three interpretation strategies are not mutually exclusive, and they can be conducted in tandem. For example, an analyst may initially apply a suspect analysis to search the chromatogram for a suspected chemical family, then apply a non-target analysis to further investigate constituents discovered by the suspect analysis, and finally confirm the non-target interpretation by a target analysis with injected pure standards.

In non-target analysis, the analyst aims to interpret the chemical identity of an eluting constituent in a sample, with little or no prior information about the chemical identity. To support a non-target analysis, peaks are measured in each of the relevant spectral channels in the chromatogram sub-region where the constituent elutes. In an embodiment, the method pre-evaluates the signal data of all spectral channels of the sub-region of interest; the method can accept for further consideration only those channels that exceed a minimum peaklet height threshold. Peaks are measured in each accepted channel, producing a list of peak retention times and peak heights for that channel. Spectral peaks are detected by the co-occurrence of individual channel peaks that fall within a retention time locus parameterized as an acceptance oval. The analyst parameterizes the size of the acceptance oval. The method produces a deconvoluted spectrum of the constituent as the set of spectrum channel values (e.g., m/z values) and channel peak heights (spectral intensities) of the measured channel peaks at that retention time locus. The analyst can interpret the deconvoluted spectrum of the constituent by conventional means, such as with reference libraries. Other methods may be used to support the non-target analysis, and the invention is not limited thereby.

In suspect analysis, the analyst aims to verify the occurrence of a constituent or family of constituents in a sample, based on experimental or theoretical information about the spectrum of the constituent(s). To support a suspect analysis, peaks are measured in each of a pre-selected set of spectral channels of the chromatogram, based on prior information about the analyte spectrum. To obtain the deconvoluted spectra and retention times of the suspect analytes, the method then applies the acceptance oval described previously for the non-target analysis. The analyst can interpret the deconvoluted spectrum of each discovered suspect analyte by evaluating the agreement with the pre-selected set of spectral channels.

In target analysis, the analyst aims to verify the occurrence of a chemical in a sample, having knowledge of both the experimental spectrum and retention time based on an injected pure standard of that chemical. To support a target analysis, peaks are measured for known set of spectral channels in the chromatogram sub-region where the target analyte elutes, based the experimentally measured spectrum of the injected pure standard. In an embodiment, the method measures peaks in the set of known channels and applies an acceptance oval as described previously for the suspect analysis and non-target analysis. The analyst then evaluates whether the target spectrum and retention time are confirmed in the sample chromatogram.

### VIII. Example Systems

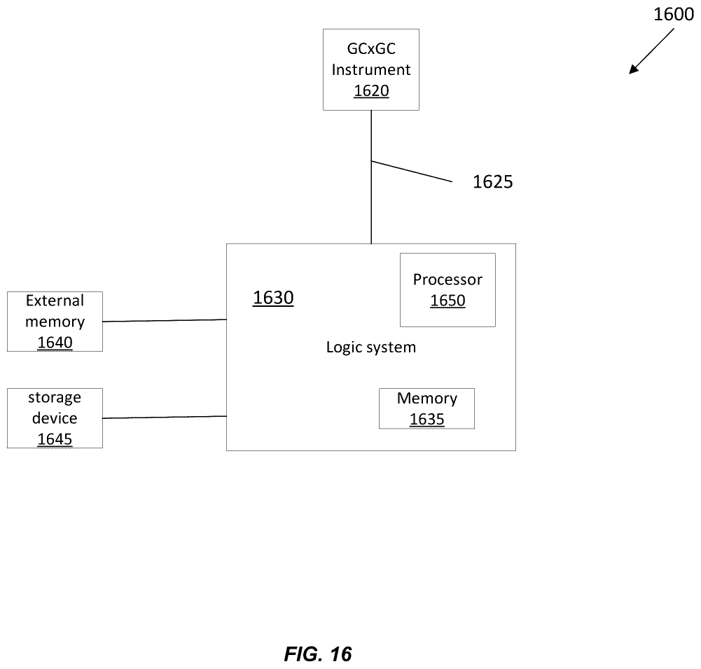

FIG. 16 illustrates a measurement system 1600 according to an embodiment of the present disclosure. The system as shown includes a GC×GC instrument 1620, e.g., as described herein. A data signal 1625 is sent from GC×GC instrument 1620 to logic system 1630. As an example, data signal 1625 can be used to determine a GC×GC chromatogram. Data signal 1625 can include various measurements made at a same time, e.g., a spectrum of intensities at multiple values of mass or wavelength, or sequentially in time, and thus data signal 1625 can correspond to multiple signals. Data signal 1625 may be stored in a local memory 1635, an external memory 1640, or a storage device 1645.

Logic system 1630 may be, or may include, a computer system, ASIC, microprocessor, graphics processing unit (GPU), etc. It may also include or be coupled with a display (e.g., monitor, LED display, etc.) and a user input device (e.g., mouse, keyboard, buttons, etc.). Logic system 1630 and the other components may be part of a stand-alone or network connected computer system, or they may be directly attached to or incorporated in a device that includes GC×GC instrument 1620. Logic system 1630 may also include software that executes in a processor 1650. Logic system 1630 may include a computer readable medium storing instructions for controlling measurement system 1600 to perform any of the methods described herein. For example, logic system 1630 can provide commands to a system that includes GC×GC instrument 1620 such that physical operations are performed. Such physical operations can be performed in a particular order, e.g., with samples being injected in a particular order. Such physical operations may be performed by a robotics system, e.g., including a robotic arm, as may be used to obtain a sample and perform an assay.

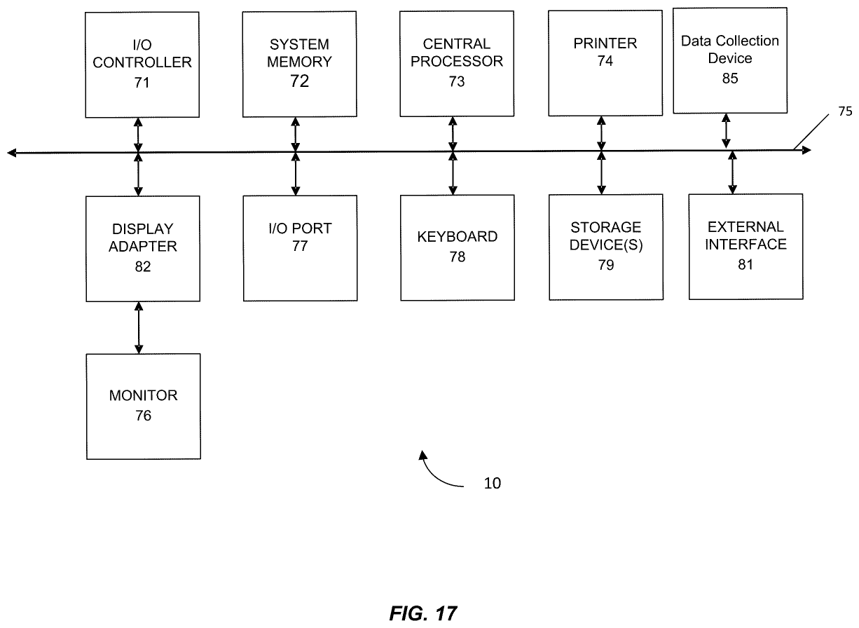

Any of the computer systems mentioned herein may utilize any suitable number of subsystems. Examples of such subsystems are shown in FIG. 17 in computer system 10. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 17 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire©). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communications between devices, including at least 100, 200, 500, 1,000, 10,000, 50,000, 100,000, 500,00, or one million communications. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl, Python, or Matlab using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

All patents, patent applications, publications, and descriptions mentioned herein are incorporated by reference in their entirety for all purposes. None is admitted to be prior art. Where a conflict exists between the instant application and a reference provided herein, the instant application shall dominate.

### IX. REFERENCES

Arey, J. S., R. K. Nelson, L. Xu, and C. M. Reddy (2005). “Using comprehensive two-dimensional gas chromatography retention indices to estimate environmental partitioning properties for a complete set of diesel fuel hydrocarbons”, Analytical Chemistry, 77 (22): 7172-7182.
Arey, J. S., R. K. Nelson and C. M. Reddy (2007). “Disentangling oil weathering using GC×GC. “Chromatogram analysis.” Environmental Science & Technology 41(16): 5738-5746.
Di Marco, V. B. and G. G. Bombi (2001). “Mathematical functions for the representation of chromatographic peaks.” Journal of Chromatography A 931(1-2): 1-30.
Eilers, P. H. (2004). “Parametric time warping.” Analytical chemistry 76(2): 404-411.
Giddings, J. C. (1965). Dynamics of Chromatography: Principles and Theory. New York, Marcel Dekker Inc.
Grob, R. L. and E. F. Barry (2004). Modern practice of gas chromatography, John Wiley & Sons.
Gros, J., D. Nabi, P. Dimitriou-Christidis, R. Rutler and J. S. Arey (2012). “Robust Algorithm for Aligning Two-Dimensional Chromatograms.” Analytical Chemistry 84: 9033-9040.
Klee, M. S. and L. M. Blumberg (2010). “Measurement of retention in comprehensive two-dimensional gas chromatography using flow modulation with methane dopant.” Journal of Chromatography A 1217(11): 1830-1837.
Latha, I., S. E. Reichenbach and Q. Tao (2011). “Comparative analysis of peak-detection techniques for comprehensive two-dimensional chromatography.” Journal of Chromatography A 1218(38): 6792-6798.
Lopatka, M., G. Vivó-Truyols and M. Sjerps (2014). “Probabilistic peak detection for first-order chromatographic data.” Analytica Chimica Acta 817: 9-16.
Nelson, R. K., J. Forsythe, C. Eiserbeck, A. G. Scarlett, K. Grice, O. C. Mullins and C. M.
Reddy (2022). “GC×GC Analysis of Novel 2α-Methyl Biomarker Compounds from a Large Middle East Oilfield.” Energy & Fuels 36(16): 8853-8865.
Peters, S., G. Vivó-Truyols, P. J. Marriott and P. J. Schoenmakers (2007). “Development of an algorithm for peak detection in comprehensive two-dimensional chromatography.” Journal of Chromatography A 1156(1-2): 14-24.
Reichenbach, S. E., M. Ni, V. Kottapalli and A. Visvanathan (2004). “Information technologies for comprehensive two-dimensional gas chromatography.” Chemometrics and Intelligent Laboratory Systems 71(2): 107-120.
Reichenbach, S. E., M. Ni, D. Zhang and E. B. Ledford Jr (2003). “Image background removal in comprehensive two-dimensional gas chromatography.” Journal of Chromatography A 985(1-2): 47-56.
Samanipour, S., P. Dimitriou-Christidis, J. Gros, A. Grange and J. S. Arey (2015). “Analyte quantification with comprehensive two-dimensional gas chromatography: Assessment of methods for baseline correction, peak delineation, and matrix effect elimination for real samples.” Journal of Chromatography A 1375: 123-139.
Vivó-Truyols, G., J. R. Torres-Lapasio, A.-M. Van Nederkassel, Y. Vander Heyden and D.
Massart (2005a). “Automatic program for peak detection and deconvolution of multi-overlapped chromatographic signals: Part I: Peak detection.” Journal of Chromatography A 1096(1-2): 133-145.
Vivó-Truyols, G., J. R. Torres-Lapasio, A.-M. Van Nederkassel, Y. Vander Heyden and D.
Massart (2005b). “Automatic program for peak detection and deconvolution of multi-overlapped chromatographic signals: Part I I: Peak model and deconvolution algorithms.” Journal of Chromatography A 1096(1-2): 146-155.
Wang, J. and P. M. Willis (2019). Systems and Methods to Process Data in Chromatographic Systems. USA, LECO Corporation, U.S. Pat. No. 10,488,377 B2.

What is claimed is:

1. A method to quantify two-dimensional signal features of chemical constituents that are separated by a GC×GC instrument coupled with a chemical detector, the GC×GC instrument including a first column corresponding to a first dimension and a second column corresponding to a second dimension, the method comprising:
receiving, from the GC×GC instrument, a chromatogram including a plurality of second-dimension segments;
for each segment of the plurality of second-dimension segments:
estimating a baseline of an output of the chemical detector within each segment, and removing the baseline to obtain a baseline-corrected segment;
smoothing the baseline-corrected segment to obtain a second-dimension signal;
detecting second-dimension retention time values of candidate peaklets in each second-dimension segment of the plurality of second-dimension segments by analysis of the second-dimension signal and at least one calculated derivative;
culling the second-dimension retention time values of candidate peaklets in each second-dimension segment, thereby determining accepted second-dimension retention time values;
determining, using the accepted second-dimension retention time values that remain after culling, a width parameter of each peaklet of a plurality of peaklets in the segment using a physical model of peaklet broadening in the second column, wherein the physical model specifies the width parameter based on the second-dimension retention time values of the plurality of peaklets and a temperature of a secondary oven of the GC×GC instrument;
optimizing peaklet heights of the plurality of peaklets in the segment, thereby determining optimized peaklet heights, wherein each peaklet is specified by a peaklet shape function that includes the second-dimension retention time, width parameter, and height values of the peaklet, wherein the optimizing comprises a minimization of an absolute difference between the second-dimension signal and a sum of the peaklets;
culling the peaklets, after optimizing the peaklet heights; and
delineating two-dimensional peaks in the chromatogram, wherein delineating comprises: (i) determining groups of associated peaklets throughout the chromatogram; and (ii) splitting each group of associated peaklets into distinct two-dimensional peaks.

2. The method of claim 1, further comprising:
operating the GC×GC instrument to obtain the chromatogram for a substance that was input into the GC×GC instrument.

3. The method of claim 1, wherein estimating the baseline uses a parameterized asymmetric least-squares warping algorithm or a dead-band baseline algorithm.

4. The method of claim 1, wherein smoothing the baseline-corrected segment uses a Gaussian-weighted moving average or a Savitzky-Golay filter.

5. The method of claim 1, wherein detecting candidate peaklets comprises detecting the second-dimension retention time values of candidate peaklets by analysis of the second-dimension signal and a second derivative of the second-dimension signal.

6. The method of claim 5, wherein detecting the second-dimension retention time values of candidate peaklets comprises:
calculating the second derivative of the second-dimension signal;
detecting local maxima of the second-dimension signal; and
detecting local minima of the second derivative.

7. The method of claim 1, wherein culling the second-dimension retention time values of candidate peaklets in each second-dimension segment comprises:
accepting the second-dimension retention time values of candidate peaklets that remain after culling, by determining which second-dimension retention time values exceed a minimum peaklet height threshold; and
accepting the second-dimension retention time values of candidate peaklets that remain after culling, by determining which second-dimension retention time values comply with a minimum peaklet separation threshold.

8. The method of claim 7, wherein determining which second-dimension retention time values comply with the minimum peaklet separation threshold comprises:
selecting the second-dimension retention time values that exhibit a separation distance greater than or equal to the minimum peaklet separation threshold; and
selecting a detected second-dimension retention time value that exhibits a highest signal intensity among any subset of the second-dimension retention time values that exhibit a separation distance less than the minimum peaklet separation threshold.

9. The method of claim 7, further comprising:
assigning values of the minimum peaklet separation threshold as an empirical function of the second-dimension retention time.

10. The method of claim 1, wherein the physical model of the width parameter is represented by Eqs. 1 and 2, with a diffusivity parameter, Dₛ, that varies according to an empirical function of a first-dimension retention time.

11. The method of claim 1, wherein optimizing the peaklet heights in a segment comprises a constrained minimization of the absolute difference between the second-dimension signal and a sum of peaklet shape functions, wherein each peaklet shape function is parameterized with a second-dimension retention time, a width parameter, and a height.

12. The method of claim 11, wherein each peaklet shape function comprises an Exponentially Modified Gaussian function.

13. The method of claim 11, wherein the constrained minimization includes applying an interior-point minimization algorithm subject to the following constraints: (i) all peaklet heights are equal to or less than the second-dimension signal at that peaklet retention time and (ii) all peaklet heights are greater than zero.

14. The method of claim 1, wherein culling the peaklets includes eliminating any peaklet with an optimized peaklet height below a minimum peaklet height threshold.

15. The method of claim 1, wherein delineating two-dimensional peaks throughout the chromatogram comprises:
(i) determining groups of associated peaklets, by detecting contiguously neighboring peaklets in the first dimension such that each neighboring pair exhibits a distance equal to or less than half of a minimum peaklet separation threshold in the second dimension; and
(ii) splitting each group of associated peaklets into two-dimensional peaks by iteratively analyzing a first-dimension profile of peaklet heights within a group, such that each two-dimensional peak exhibits a local maximum in the first dimension, conforms to a maximum peaklet number, and conforms to a minimum concavity criterion.

16. The method of claim 1, further comprising:
deconvoluting spectral chromatograms to support an interpretation of a chemical identity of the chemical constituents.

17. The method of claim 16, wherein deconvoluting spectral chromatograms includes at least one selected from a group consisting of a non-target analysis, a suspect analysis, and a target analysis.

18. The method of claim 16, wherein deconvoluting spectral chromatograms comprises:
measuring peaks in each of a plurality of relevant spectral channels in a chromatogram sub-region of interest;
detecting spectral peaks by a co-occurrence of individual channel peaks that fall within a retention time locus parameterized as an acceptance oval; and
expressing a deconvoluted spectrum of a detectable constituent as a set of spectrum channel values and channel peak heights of the individual channel peaks at the retention time locus.

19. The method of claim 18, wherein the set of spectrum channel values include m/z values.

20. The method of claim 18, wherein the channel peak heights correspond to spectral intensities.
